(19) United States
(12) Patent Application Publication
(10) Pub. No.: US 2016/0097175 A1
(43) Pub. Date: Apr. 7, 2016

(54) AGGREGATE REPLACEMENT

(71) Applicant: Alton F. Parker, Clifton Park, NY (US)

(72) Inventor: Alton F. Parker, Clifton Park, NY (US)

(21) Appl. No.: 14/967,008

(22) Filed: Dec. 11, 2015

Related U.S. Application Data
(63) Continuation-in-part of application No. 14/864,546, filed on Sep. 24, 2015.
Application No. 14/864,546 is a continuation-in-part of application No. 14/282,801, filed on May 20, 2014, now Pat. No. 9,206,574.
Application No. 14/282,801 is a continuation-in-part of application No. 13/851,004, filed on Mar. 26, 2013, now Pat. No. 9,139,971.

(51) Int. Cl. E02B 11/00; E03F 1/00; F16M 13/02; F16L 1/036; F16L 1/06

(52) U.S. Cl. CPC E02B 11/005; F16L 1/036; F16L 1/06; F16M 13/022; E03F 1/002

(57) ABSTRACT

An aggregate replacement device may be used to replace rock aggregate in underground drainage systems. An aggregate replacement includes a first unit having at least two faces, a proximal end and a distal end. A plurality of openings may be formed in the at least two faces. The at least two faces have a proximal edge, a distal edge and two side edges. One of the two side edges of a first of the at least two faces is configured to couple to one of the two side edges of a second of the at least two faces. The aggregate replacement may also have a camera receiver. The aggregate replacement may be used as a concrete form.

### CROSS-REFERENCE TO RELATED APPLICATION

This application is a continuation in part of pending U.S. application Ser. No. 14/864,546, which is a continuation-in-part of pending U.S. patent application Ser. No. 14/282,801 to Alton Parker entitled “AGGREGATE REPLACEMENT”, filed May 20, 2014, which is a continuation-in-part of issued U.S. Pat. No. 9,139,971 to Alton Parker entitled “AGGREGATE REPLACEMENT”, the content of which are incorporated herein by reference.

### BACKGROUND OF THE INVENTION

1. Technical Field

This invention relates to French drains and in particular to a device which can be used to replace the aggregate used in French drains or other water distribution systems.

2. Background Art

French drains are widely used in residential and commercial building applications to collect groundwater and distribute it away from the proximity of basements, foundations, footings, and similar surface and subterranean building structures where water may penetrate and/or damage these structures. An additional use of this technology is to deliver water into the sub-surface of the ground. For example, a French drain may be used to distribute fluid into the drain field of a residential septic system.

Various structures have been developed over the last two hundred years to accomplish this diversion of fluids. Generally, they consist of a pipe containing multiple small perforations throughout its sidewall through which water or fluid enters the pipe. The fluid then travels down the pipe to a desired location. To keep the perforations in the pipe from clogging, and to prevent dirt or other material from the surrounding substrate from entering the pipe, the pipe is laid within a bed of solid granular material that creates a porous aggregate unrestrictive to the flow of fluid, such as gravel, or a similar synthetic aggregate. Finally, a woven, coarse, landscape textile or filter fabric is used to surround and cover the aggregate to prevent the aggregate from becoming clogged with dirt or other surrounding substrate. The pipe, surrounding aggregate, and textile are typically installed within a trench which is then filled to grade level with dirt or other substrate. Rainwater or other surface water in the area seeps from the surrounding substrate through the textile where it may trickle freely through the aggregate into the pipe for removal from the area.

One significant problem with this system is the labor and expense necessary to surround the pipe with the aggregate. Also, if the aggregate is too heavy or is not placed carefully on top of the pipe, the pipe may break or collapse while the aggregate is being placed. This can cause time consuming and expensive problems.

Various inventions have been made in order to try and prevent these problems. For example, U.S. Pat. No. 5,810,509 issued to Nahlik, Jr. discloses a cell system for buried drainage pipes. These cells, however, cannot be used to form continuous French drains. Instead, there are individual cells that are spaced throughout the drainage area. These cells also do not protect the areas of pipe between the cells and therefore there may be a problem with these areas of pipe being damaged when the trench they are laid in is filled.

U.S. Pat. No. 7,191,802 issued to Koerner (hereinafter “Koerner”) and U.S. Pat. No. 5,051,028 issued to Houck et al. (hereinafter “Houck”), also attempt to improve French drains by replacing the standard aggregate. They, however, do not allow the aggregate replacement and pipe to be easily assembled on site.

Instead Houck discloses units that are manufactured as one piece with sections of perforated pipe inside. Multiple units are hooked together. Therefore if a section of pipe becomes damaged, the entire unit must be replaced rather than just the pipe.

Koerner discloses a system where netting filled with aggregate is wrapped along a perforated pipe. This system takes too long to conveniently assemble on site and therefore will likely need to be preassembled. Therefore if the pipe gets damaged the entire assembly will need to be replaced rather than simply replacing the pipe.

Also, while these patents claim to protect the pipe, in reality they would provide very little protection to the pipe when the trench is being filled in with substrate.

Additionally, many of the systems in the prior art are expensive to ship and store as they are bulky and require considerable space.

Accordingly, what is needed is an aggregate replacement device that is light weight, easy to use, quick to install and which allows the pipe to be accessed and inserted after the aggregate replacement has been placed in the trench. Further, an aggregate replacement device which takes up very little space when it is being shipped or stored is also desirable.

### DISCLOSURE OF THE INVENTION

The aggregate replacement device, as disclosed hereafter in this application, is strong, lightweight and easy to assemble.

In particular embodiments, an aggregate replacement device includes a structure with a proximal end, a distal end, and at least one face wherein the at least one face includes a plurality of first openings. A second opening in the structure extends from the proximal end to the distal end continuing uninterrupted through at least one of the at least one faces. The second opening is configured to receive at least one pipe inserted in a radial direction of the at least one pipe.

Additional embodiments of an aggregate replacement device may include a structure having a proximal end, a distal end, and at least one face that is water permeable. The aggregate replacement device may also include an opening in the at least one outer face that extends from the proximal end to the distal end of the structure continuously. The opening may be configured to receive at least one pipe inserted in a radial direction of the at least one pipe. The opening may further include at least one pipe retainer.

Other embodiments of an aggregate replacement device may include a structure having a proximal end, a distal end, and at least two faces. The at least two faces further contain a plurality of first openings. A stake may be coupled to the structure to secure the structure in a desired position. A concrete barrier may be placed abutting at least one of the at least two faces. An second opening in the structure may extend from the proximal end of the structure to the distal end of the structure continuing uninterrupted through at least one of the at least two faces. The second opening, however, continues through a different at least one of the at least two faces than the concrete barrier abuts. The second opening may be configured to receive at least one pipe inserted in a radial direction of the at least one pipe.

Further embodiments of an aggregate replacement device may include a structure having a proximal end, a distal end, and at least one face. The at least one face has a plurality of first openings. A second opening may be located in the proximal end. A third opening may also be located in the structure. A first end of a pipe is in communication with the second opening and the pipe extends through the structure. A second end of the pipe is in communication with the third opening.

Embodiments of an aggregate replacement device may also include a structure having a proximal end, a distal end, and at least one face. The at least one face may have a plurality of first openings. The proximal end may also comprise at least one cutout, wherein the at least one cutout intersects an edge of the proximal end.

Yet more embodiments of an aggregate replacement device may include at least one face, wherein the at least one face has a plurality of openings. At least one coupler may be coupled to the at least one face. At least one distal end and at least one proximal end may be hingedly coupled to at least one the at least one face.

Additional embodiments of an aggregate replacement device may include a section having a proximal end, a distal end and at least one face. A plurality of openings may be formed in the at least one face. The at least one face may have a proximal edge, a distal edge and two side edges. The proximal end may be coupled to the proximal edge of the at least one face forming an obtuse angle between the proximal end and the at least one face. The distal end may be coupled to the distal edge of the at least one face forming an obtuse angle between the distal end and the at least one face. The at least one coupler may be coupled to two of the two side edges of the at least one face for coupling the section to a second section.

Further embodiments of an aggregate replacement device may include at least one structure having a proximal face, a distal face, at least one additional face and a mating opening. A plurality of flow openings may be formed in the at least one additional face. The distal face may be coupled to a distal end of the at least one additional face and the proximal face may be coupled to a proximal end of the at least one additional face. The mating opening is formed between the proximal face and the distal face. A pipe support may be coupled to the at least one additional face at a location opposite the mating opening. The at least one structure is configured to couple to a second at least one structure. When the at least one structure is coupled to the second at least one structure, the mating opening of the at least one structure is adjacent the mating opening of the second at least one structure.

Other embodiments of an aggregate replacement device may include a structure having a proximal face, a distal face, a bottom face and two side faces. The two side faces and the bottom face have a plurality of openings. The two side faces and the bottom face each further include a proximal edge, a distal edge and two side edges. The proximal face is coupled to each of the proximal edges of the two side faces and the bottom face. The distal face is coupled to each of the distal edges of the two side faces and the bottom face. A first of the two side edges of each of the two side faces is coupled to one of the two side edges of the bottom face. At least one coupler is coupled to a second of the two side edges of each of the two side faces. At least one locking device is coupled to the second of the two side edges of each of the two side faces. The at least one coupler configured to couple the structure to a second structure with the second of the two side edges of each of the two side faces abutting on each of the structure and the second structure. The at least one locking device configured to lock the structure to the second structure.

Still additional embodiments of an aggregate replacement device include a first unit having at least two faces, a proximal end and a distal end. A plurality of openings may be formed in the at least two faces and the at least two faces having a proximal edge, a distal edge and two side edges, wherein one of the two side edges of a first of the at least two faces is configured to couple to one of the two side edges of a second of the at least two faces.

Further embodiments may include a first section having a proximal end, a distal end and at least one face and wherein the proximal end and the distal end are open. At least one coupler may be coupled to the first section. A second section having a proximal end, a distal end and at least one face and wherein the proximal end and the distal end are open. At least one receiver may be coupled to the second section. Wherein the first section is configured to couple to the second section with the at least one coupler being received into the at least one receiver to form a unit.

More embodiments may include a first unit having at least two faces, a proximal end and a distal end with a plurality of openings formed in the at least two faces. The at least two faces have a proximal edge, a distal edge and two side edges, wherein one of the two side edges of a first of the at least two faces is configured to couple to one of the two side edges of a second of the at least two faces. A camera receiver may be formed in the first unit.

The foregoing and other features and advantages of the aggregate replacement device will be apparent to those of ordinary skill in the art from the following more particular description of the invention and the accompanying drawings.

### BRIEF DESCRIPTION OF THE DRAWINGS

The invention will hereinafter be described in conjunction with the appended drawings where like designations denote like elements, and:

FIG. 1 is an isometric view of an aggregate replacement configured according to a first embodiment;

FIG. 2 is an isometric view of an aggregate replacement configured according to a second embodiment;

FIG. 3 is a first side view of an aggregate replacement configured according to the embodiments of FIG. 1;

FIG. 4 is a second side view of an aggregate replacement configured according to the embodiments of FIG. 1;

FIG. 5 is an end view of an aggregate replacement configured according to the embodiments of FIG. 1;

FIG. 6 is an isometric view of an aggregate replacement covered by a liner configured according to a third embodiment;

FIG. 7 is an isometric view of an aggregate replacement configured according to a fourth embodiment;

FIG. 8 is an isometric view of an aggregate replacement configured according to a fifth embodiment;

FIG. 9 is an isometric view of an aggregate replacement configured according to a sixth embodiment;

FIG. 10 is an isometric view of an aggregate replacement configured according to a seventh embodiment;

FIG. 11 is a close up view of an area denoted by A in FIG. 2;

FIG. 12 is an isometric view of an aggregate replacement concrete form configured according to an embodiment;

FIG. 13 is an isometric view of an aggregate replacement configured according to a seventh embodiment;

FIG. 14 is an isometric view of an aggregate replacement configured according to an eighth embodiment;

FIG. 15 is an isometric view of an aggregate replacement configured according to a ninth embodiment;

FIG. 16 is an isometric view of an aggregate replacement configured according to a tenth embodiment;

FIG. 17 is an isometric view of an aggregate replacement configured according to an eleventh embodiment;

FIG. 18 is a top view of an aggregate replacement configured according to a twelfth embodiment;

FIG. 19 is an isometric view of an aggregate replacement concrete form configured according to a second embodiment;

FIG. 20 is an isometric view of an aggregate replacement concrete form configured according to a third embodiment;

FIG. 21 is an isometric view of an aggregate replacement configured according to a thirteenth embodiment;

FIG. 22 is a side view of an aggregate replacement configured according to a thirteenth embodiment;

FIG. 23 is a top view of an aggregate replacement configured according to a thirteenth embodiment;

FIG. 24 is an isometric view of a single unit of aggregate replacement configured according to a thirteenth embodiment;

FIG. 25 is an end view of a single unit of an aggregate replacement configured according to a thirteenth embodiment;

FIG. 26 is a top view of a single unit of an aggregate replacement configured according to a thirteenth embodiment;

FIG. 27 is an exploded isometric view of a single unit of an aggregate replacement configured according to a thirteenth embodiment;

FIG. 28 is an isometric view of a section of an aggregate replacement configured according to a thirteenth embodiment;

FIG. 29 is a side view of a section of an aggregate replacement configured according to a thirteenth embodiment;

FIG. 30 is an inside view of a section of an aggregate replacement configured according to a thirteenth embodiment;

FIG. 31 is an isometric view of a pipe-less aggregate replacement;

FIG. 32 is an end view of a pipe-less aggregate replacement;

FIG. 33 is an isometric view of a section of pipe-less aggregate replacement;

FIG. 34 is an isometric view of a first open ended embodiment of an aggregate replacement;

FIG. 35 is a side view of a second open ended embodiment of an aggregate replacement;

FIG. 36 is an isometric view of a third open ended embodiment of an aggregate replacement;

FIG. 37 is an exploded view of a fourth open ended embodiment of an aggregate replacement;

FIG. 38 is an exploded view of a fifth open ended embodiment of an aggregate replacement;

FIG. 39 is an exploded view of a sixth open ended embodiment of an aggregate replacement;

FIG. 40 is an isometric view of a section of a sixth open ended embodiment of an aggregate replacement;

FIG. 41 is an end view of a section of a sixth open ended embodiment of an aggregate replacement;

FIG. 42 is an exploded view of a seventh open ended embodiment of an aggregate replacement;

FIG. 43 is an exploded view of a solid concrete form embodiment of an aggregate replacement;

FIG. 44 is an end view of an embodiment of an aggregate replacement with camera receiver openings;

FIG. 45 is top view of an embodiment of an aggregate replacement with a corner section; and

FIG. 46 is a cross-section of an embodiment of an aggregate replacement taken at line 46-46 of FIG. 45.

### DESCRIPTION OF THE INVENTION

As discussed above, embodiments of the present invention relate to an aggregate replacement device for use in French drains and the like. In particular, disclosed is an aggregate replacement device including a structure with fluid permeable surfaces, and an opening configured to receive a pipe inserted parallel to a diameter of the pipe.

When French drains or other drainage or fluid distribution systems are set up, a trench is dug in the ground in the area where the water is to be drained from. The trench is then lined with a landscape, filter fabric or other water permeable material which prevents the soil or substrate from the surrounding area from entering the trench. Aggregate may then be placed in the bottom of the trench. This aggregate is typically washed gravel or a synthetic aggregate that allows water to flow freely through. A perforated pipe is then placed on top of the aggregate. The perforated pipe could also be placed directly on the filter fabric in the bottom of the trench. The perforated pipe is then covered with additional aggregate. The top of the additional aggregate may have more filter fabric placed on it. Then top soil and plants may be placed on the filter fabric hiding the French drain underground.

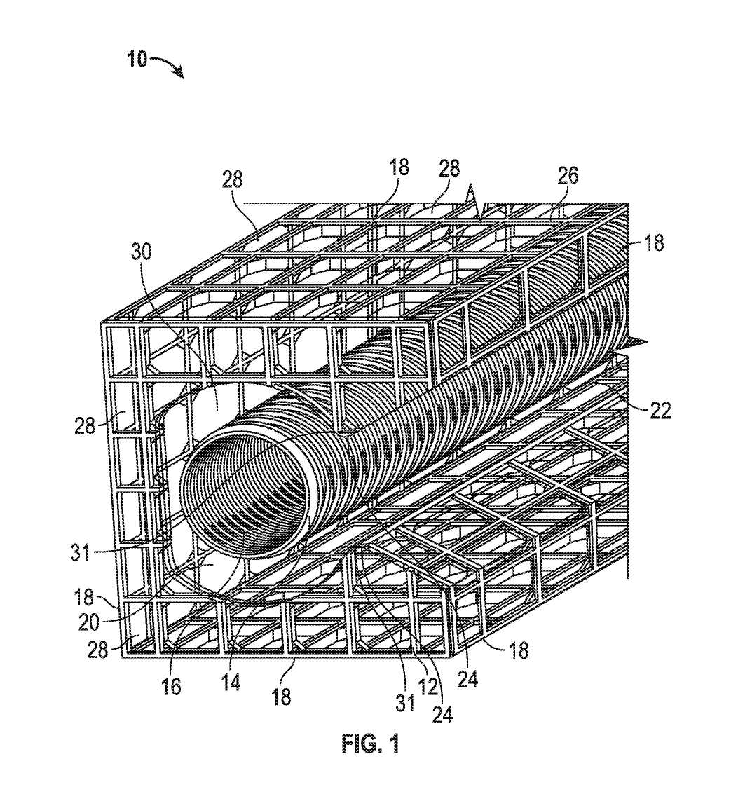

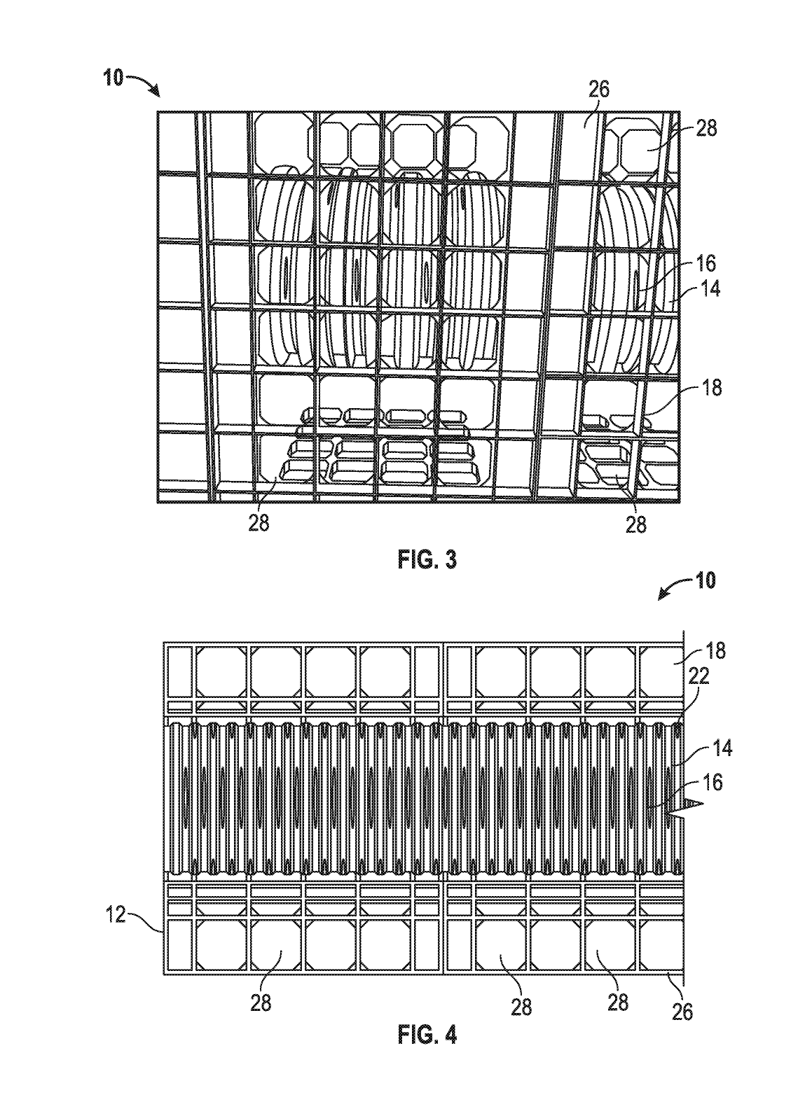

FIGS. 1-6 illustrate an aggregate replacement 10 configured according to embodiments of the present invention. The aggregate replacement 10 takes the place of the washed gravel or synthetic aggregate in a French drain or other water distribution system.

The aggregate replacement 10 includes a structure 26 which is formed as an open scaffolding. The structure 26 includes a proximal end 12, a distal end 32 and at least one face 18. The proximal end 12 is coupled to the at least one face 18. In the figures, the proximal end 12 is coupled at a 90 degree angle to four faces 18. The four faces 18 illustrated are rectangular or square. It is anticipated, however, that only one face 18 could be used. This face 18 would be curved in order to form a cylindrical aggregate replacement. It is also anticipated that three faces 18 could be utilized in order to form a structure with a triangular cross section. A plurality of faces 18 greater than four could also be used to form the structure 26. The number of faces 18 and the desired shape of the structure 26 will determine the angle at which the faces are coupled to the proximal end 12. The four faces 18, shown in the figures, are also coupled to each other at 90 degree angles. The angle at which the faces 18 are coupled to each other will vary depending on the number and shape of faces 18 utilized. The distal end 32 is coupled to the remaining open edges of the four faces 18. The arrangement described and depicted in the figures results in a cube or rectangular prism shaped structure 26. However, the structure 26 may be any type of shape desired. The at least one face 18, proximal end 12, and distal end 32 may also be formed in any shape desired.

In additional embodiments, the structure 26 may be curved in order to form circular, serpentine or other irregularly shaped drains.

The structure 26 forms a mostly hollow interior 20. The mostly hollow interior 20 may contain supports or other devices necessary to strengthen the structure 26. However, these devices should not impede the flow of water in the interior 20 of the structure 26. The mostly hollow interior 20 of the structure 26 allows water to drain through the structure 26 just like water would drain through the washed gravel or synthetic aggregate of traditional drains.

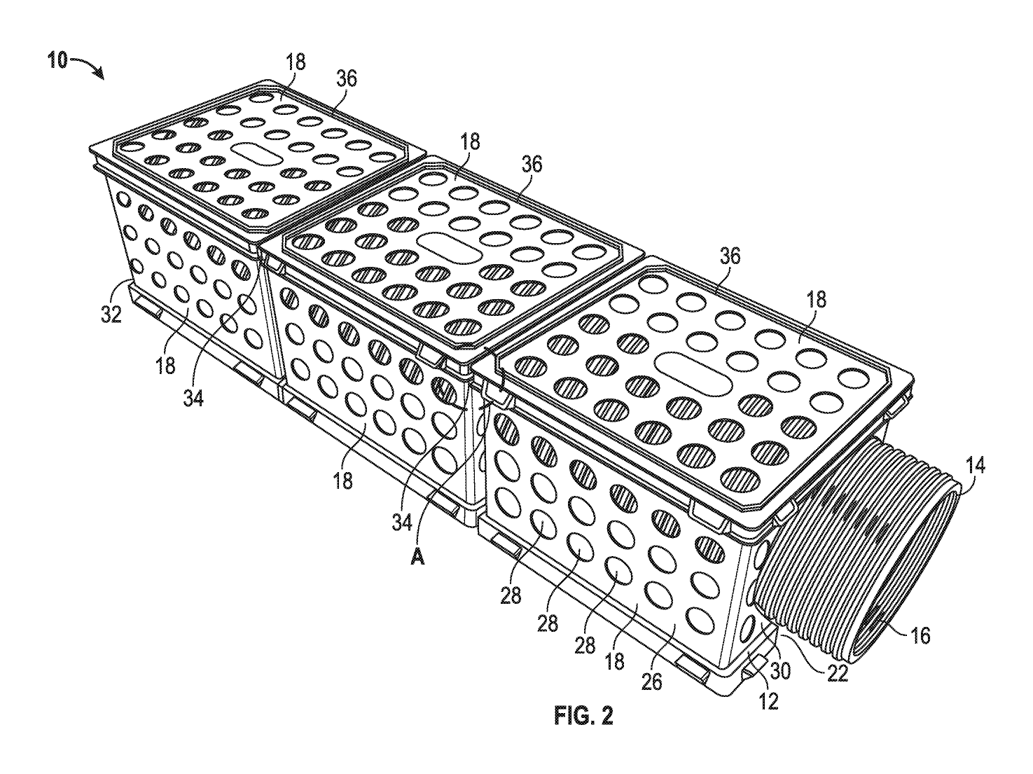

The proximal end 12, distal end 32 and at least one face 18 are water permeable. This is accomplished by forming at least one first opening 28 in the proximal end 12, distal end 32 and at least one face 18. In FIG. 1, the proximal end 12, distal end 32 and four faces 18 are all formed with multiple square openings 28 separated by thin structural members which help structure 26 maintain its shape while allowing fluid, typically water, to pass easily through the proximal end 12, distal end 32 and faces 18. FIG. 2 has multiple round openings 28 in the proximal end 12, distal end 32 and at least one face 18. The at least one first opening 28 may be any size or shape desired so long as the openings 28 are a size and shape that allow water to easily permeate the surfaces of the structure 26 and enter the mostly hollow interior 20.

It alternate embodiments, the proximal end 12, the distal end 32 of the structure 26 and at least one but not all of the faces 18 may not contain any openings 28.

The aggregate replacement 10 may be formed as one single piece that runs the entire length of the drain or it may be formed in smaller pieces that are connected together. FIG. 2 illustrates an embodiment of an aggregate replacement 10 which is composed of multiple units 36 which are coupled together with connectors 34. These connectors 34 may be any type of connector that holds two aggregate replacement units 36 together. FIG. 11 is a close up of section A from FIG. 2. FIG. 11 shows a connector 34. In this illustration, the connector is a pin 48 which slides into a receiver 50. The pin 48 is simply a cylindrical extension from the structure 26 of the aggregate replacement 10. The receiver 50 is an open cylindrical extension of the structure 26 of the aggregate replacement 10. The pin and the receiver are close enough in size that by inserting the pin 48 into the receiver 50, the units 36 are kept reasonably securely connected.

In alternate embodiments, the connector 34 may be flexible in order to allow the units 36 to be connected in a circular, serpentine, or non-linear arrangement.

In other embodiments, multiple units 36 may simply be placed adjacent each other without the use of connectors. The pipe 14 would then be inserted into the units 36. The units 36 would be held adjacent to each other by the pipe 14.

FIGS. 1-6 also show a second opening in a face 18 of the structure 26. The second opening may comprise an insertion opening 22, a pipe retainer and a pipe receiver 30. The insertion opening 22 is created in one of the at least one faces 18 of the structure 26. The insertion opening 22 allows a pipe 14 with perforations 16 to be inserted in a radial direction into the aggregate replacement 10. The insertion opening 22 should be large enough to allow a pipe 14 of a desired size to be inserted into the structure 26 of the aggregate replacement 10. The insertion opening 22 runs the entire length of one of the at least one faces 18 as shown FIG. 4 which is a side view of the aggregate replacement 10.

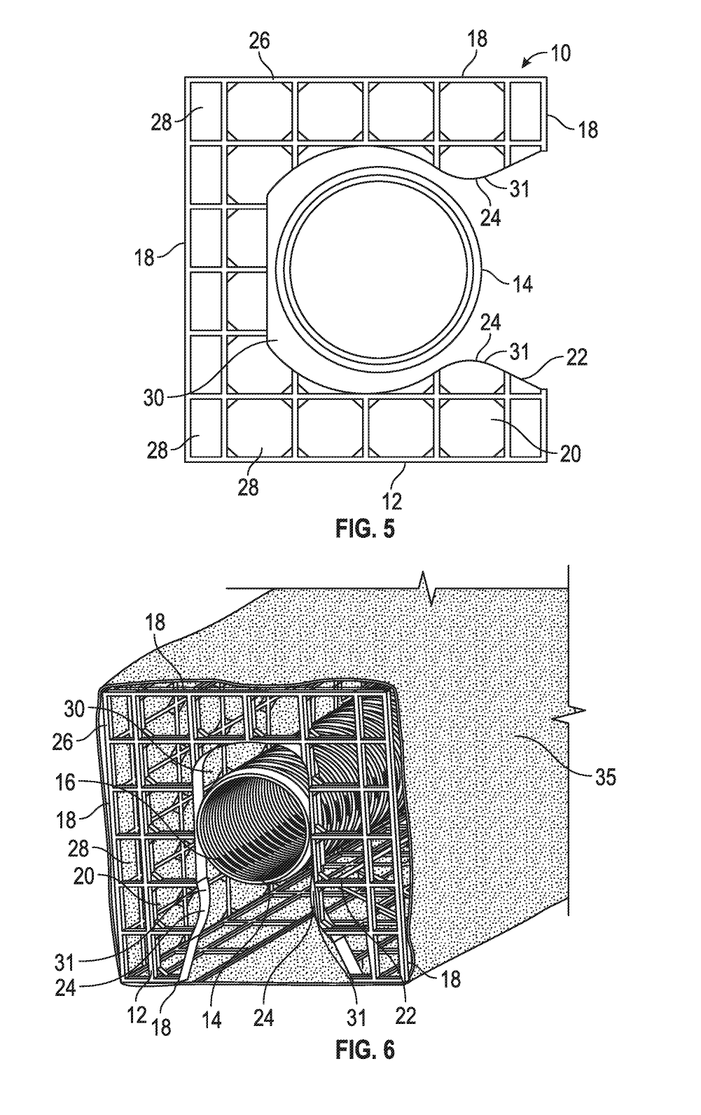

FIG. 5 is a view of the proximal 12 or distal end 32 of the structure 26. The insertion opening 22 also extends through the proximal end 12 and the distal end 32 of the structure 26. In the proximal end 12 and the distal end 32 of the structure, the insertion opening 22 forms a pipe receiver 30.

The pipe receiver 30 is an opening formed in the proximal end 12 and the distal end 32 of the structure 26. The pipe receiver 30 is slightly larger than the diameter of the pipe 14 and holds the pipe 14 when the drain is in place. The pipe receiver 30 has a mouth which connects to the insertion opening 22.

At the mouth 31 of the pipe receiver 30, may be a pipe retainer. The pipe retainer may comprise at least one protrusion 24. The at least one protrusion 24 narrows the insertion opening 22 to less than the diameter of the pipe 14. The at least one protrusion 24 may be flexible, or the pipe 14 may be slightly flexible in order to allow the pipe 14 to be forced past the at least one protrusion 24 and through the mouth 31 of the pipe receiver 30. The at least one protrusion 24 will then hold the pipe 14 within the pipe receiver 30.

The pipe retainer may also be simply a narrowing of the insertion opening 22 or in an alternate embodiment of the invention as shown in FIG. 8, the pipe retainer may be tabs 25 manufactured at the mouth of a U shaped pipe receiver 30. The tabs 25 along with the U shaped pipe receiver 30 act to hold the pipe 14 in place within the aggregate replacement 10.

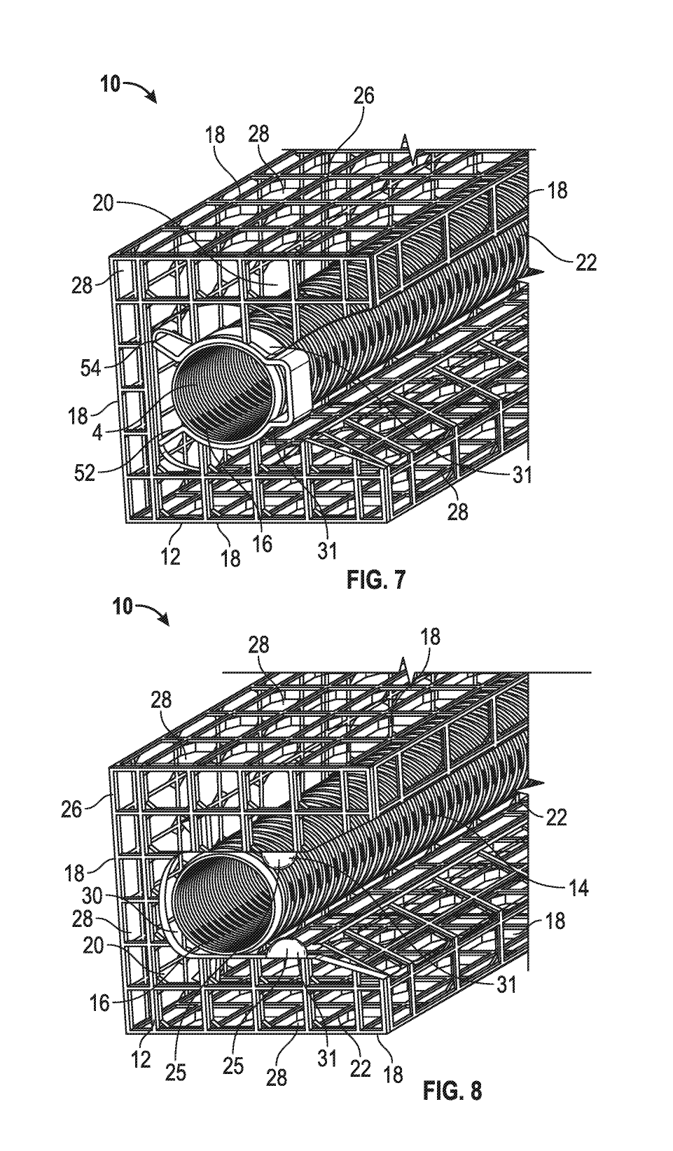

FIG. 7 illustrates an additional embodiment of the aggregate replacement 10, where the pipe retainer uses a pipe clip 52 placed on the pipe 14, prior to the pipe 14 being placed in the insertion opening 22. The pipe clip 52 is then snapped into a pipe clip retainer 54 which is formed into the edge of the pipe receiver 30. The pipe 14 is then held firmly in place in the pipe receiver 30.

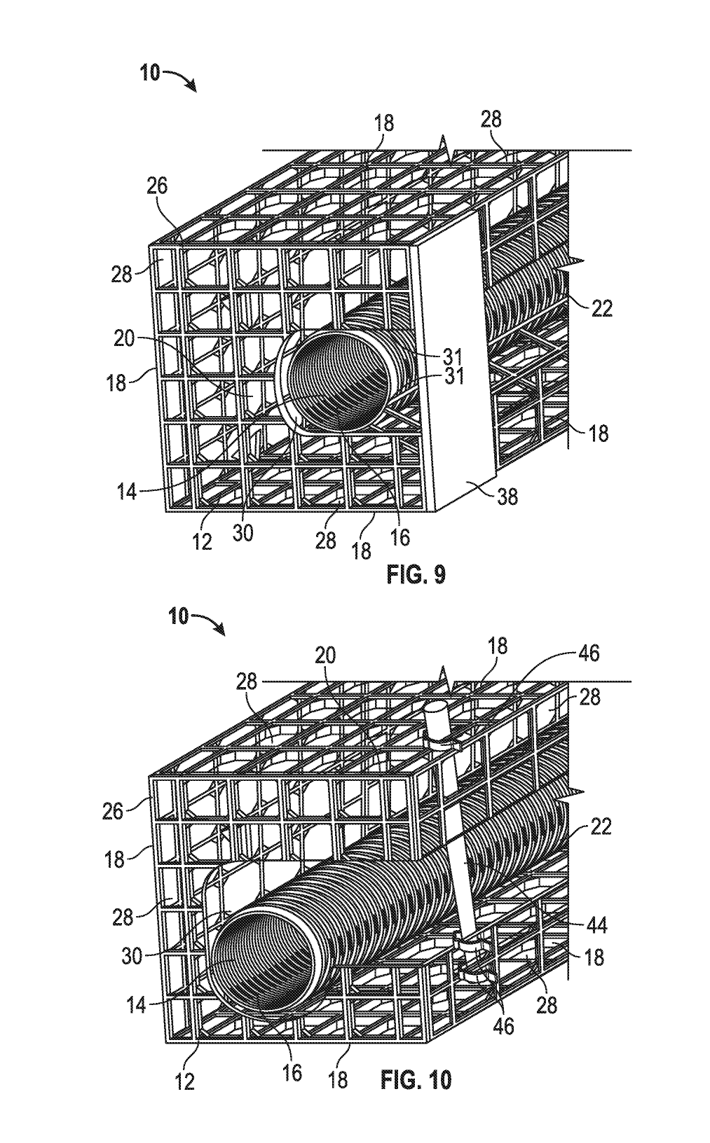

FIG. 9 illustrates yet another embodiment of the pipe retainer. In this embodiment, the pipe 14 is held in the pipe receiver 30 by a strap 38 which is coupled to the structure 26 of the aggregate replacement 10.

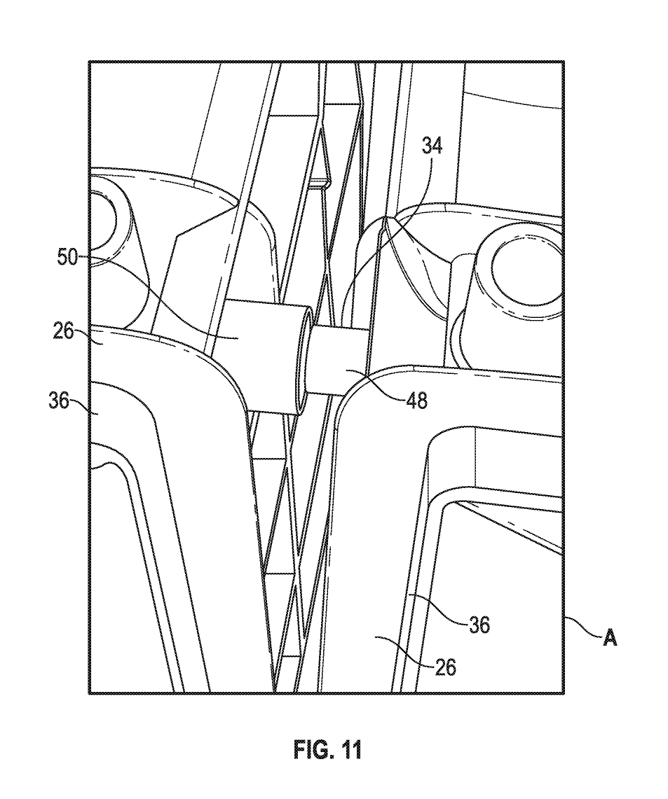

In FIG. 10, the pipe 14 is retained in place in the pipe receiver 30 by gravity. The insertion opening 22 is located slightly above the center of the pipe receiver 30. The pipe 14 passes through the insertion opening 22 and drops into the pipe receiver 30. The pipe 14 then stays in place because it is lower than the insertion opening 22.

FIG. 10 also shows a pipe retainer using a stake 44 which is placed in a stake retainer 46. The stake 44 is simply a metal or wooden stake or rigid rod that is placed inside of an opening called a stake retainer 46. The stake 44 is then usually driven into the ground under the aggregate replacement 10. The stake 44 serves two purposes. First, the stake 44 holds the aggregate replacement 10 in place. Second, the stake 44 prevents the pipe 14 from leaving the pipe receiver 30.

The stake retainer 46 may be a hole in the structure which is designed to have the stake 44 placed in it, as shown in FIG. 10. The stake retainer 46 may also be a strap which straps the stake 44 to the outside of the structure 26. The stake retainer 46 may further be a bolt or screw which bolts or screws the stake 44 to the structure 26. The stake retainer 46 may be any device which couples the stake 44 to the structure 26. Coupling the stake 44 to the structure 26 may include receiving the stake 44 in an opening, physically attaching the stake 44 to the structure 26 or the like.

Once the pipe 14 is inserted into the aggregate replacement 10, the aggregate replacement 10 is either placed in a trench lined with filter fabric or the aggregate replacement 10 is wrapped in filter fabric. FIG. 6 illustrates the aggregate replacement 10 wrapped in filter or landscape fabric 35. The filter or landscape fabric 35 is the same type of fabric used in traditional arrangements of a French drain. The fabric 35 is a water permeable material that prevents soil, rocks, substrates or other things that might clog the perforations 16 in the pipe 14 from entering the aggregate replacement 10.

In using the aggregate replacement 10 embodiments described above, a trench is dug where the drain or distribution system is to be placed. The trench is lined with a water permeable fabric 35 such as landscape fabric, filter fabric, water permeable material or the like. The aggregate replacement 10 is then assembled. If there is more than one unit 36, then the units 36 may be connected together through use of the connectors 34. The pipe 14 is then inserted through the insertion opening 22. The pipe 14 is forced past the protrusions 24 or tabs 25 if protrusions 24 or tabs 25 are being used. The pipe 14 passes through the mouth of the pipe receiver 31 and into the pipe receiver 30. If protrusions 24 or tabs 25 are not being used, then the pipe retainer is now engaged. The aggregate replacement 10 along with the pipe 14 already inserted is then laid on top of the fabric 35 in the trench. Typically, the aggregate replacement 10 will be placed in the trench with the insertion opening 22 positioned towards the bottom of the trench as shown in FIG. 6. This position places the pipe 14 towards the bottom of the trench where more water can flow through the perforations 16 into the pipe 14. The fabric 35 is then wrapped around the aggregate replacement 10 and the trench is filled in.

In alternate embodiments the aggregate replacement 10 may be wrapped in the fabric 35 prior to being placed in the trench.

The pipe 14 could also be inserted into the aggregate replacement 10 after the aggregate replacement 10 is in place in the trench.

When in use, water flows through the fabric 35 and through the openings 28 in the faces 18 of the aggregate replacement 10 structure 26. The water then flows through the perforations 16 into the pipe 14. The pipe 14 will typically be angled so that the water flows down the pipe 14 and to a desired location.

This process works in reverse for other water distribution systems such as those used in residential septic systems.

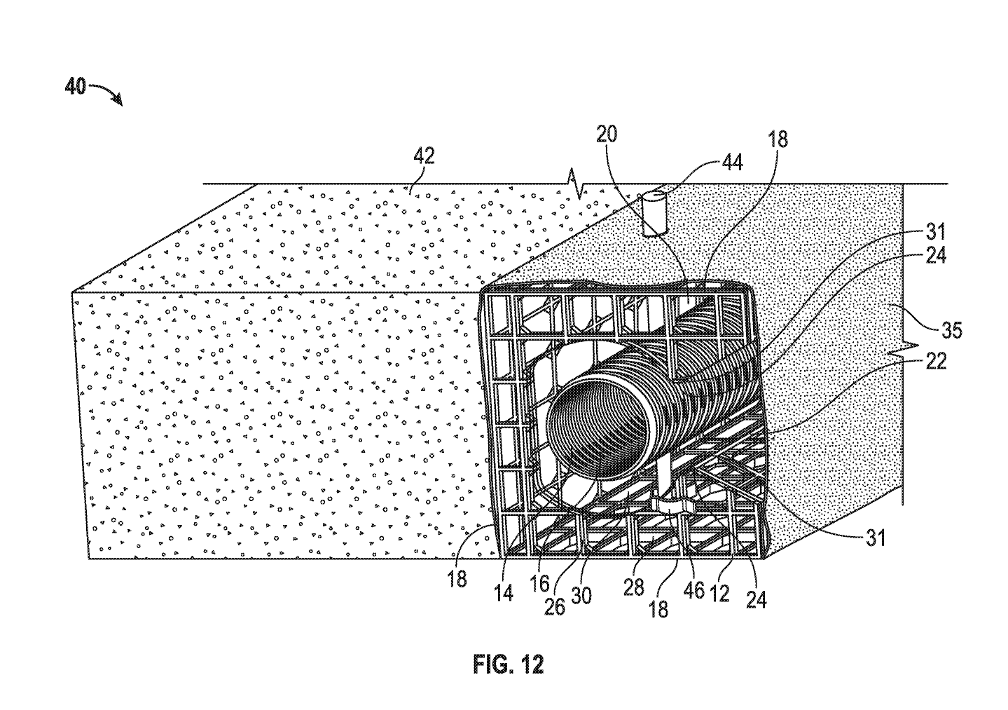

An additional embodiment of the aggregate replacement is illustrated in FIG. 12. In this embodiment, the aggregate replacement 40 is formed as described above. A stake retainer 46 may also be formed in the structure 26 on the side of the pipe receiver 30 away from the insertion opening 22. The stake 44 in this case will be used only to hold the aggregate replacement 40 in place. In alternate embodiments, a stake retainer 46 may be anything that couples the stake 44 to the structure 26. The aggregate replacement 40 is put in position with the face 18 of the structure 26 opposite the insertion opening 22 acting as a concrete form. The face 18 of the structure 26 opposite the insertion opening 22 is covered with a concrete barrier 35 such as filter fabric, landscape fabric, screen, water permeable material, solid plastic or the like. The concrete barrier 35 may or may not be water permeable. The concrete barrier 35 may be any material that retains the concrete in place while it is curing.

Concrete 42 may then be poured, with the concrete 42 coming up against the water permeable barrier 35. Once the concrete 42 has dried, the pipe 14 may be placed in the aggregate replacement 40 if it has not already been placed.

This arrangement allows moisture to be drained away from the concrete 42. The moisture travels through the material 35, passes through the aggregate replacement 40 and enters the pipe 14 through the perforations 16. The moisture then travels down the pipe 14 and away from the concrete 42.

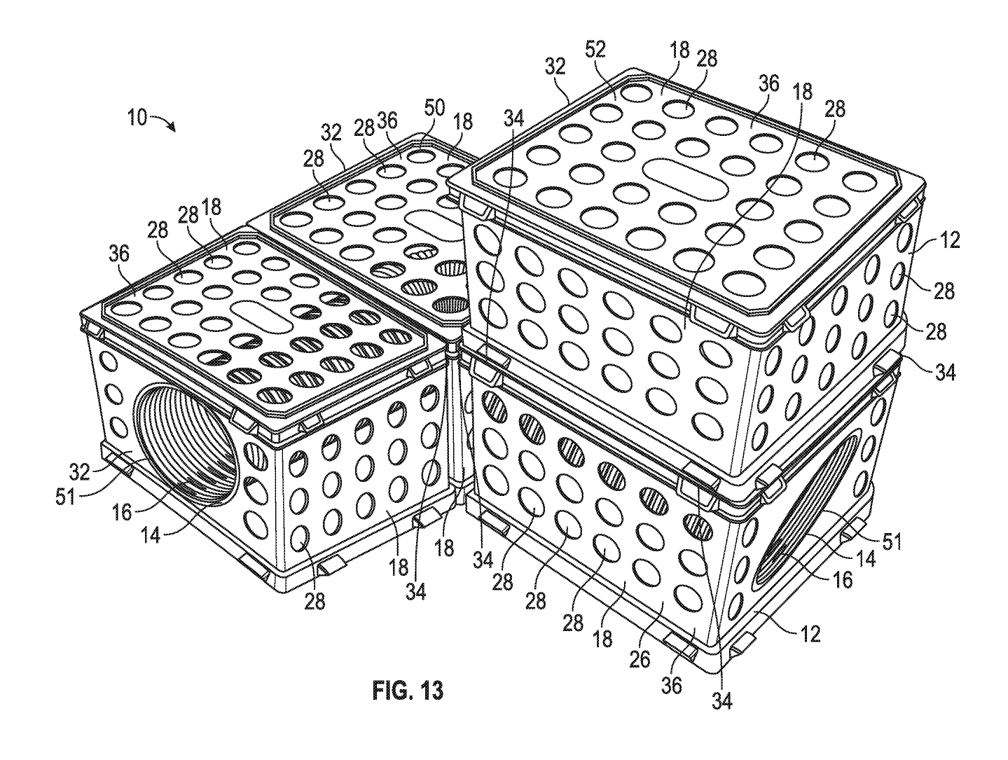

FIG. 13 illustrates another embodiment of an aggregate replacement 10. In this figure, the aggregate replacement 10 is formed from multiple units 36. Each unit 36 is formed from four faces 18. Each face 18 is illustrated as a flat rectangular member as described previously. Each face 18, however, may also be curved or angled. The face 18 may also be formed as a rectangle, square, oval, circle or the like. Each face 18 may be formed in any shape or size desired.

Each face 18 also has at least one opening 28 formed in it. Typically, multiple openings 28 will be formed in the face 18. Each opening 28 passes completely through the face 18 in order to allow fluid, such as water, to travel through the face 18 to the interior of the aggregate replacement 10. In alternate embodiments, the fluid may travel through the face 18 to the exterior of the aggregate replacement 10.

The openings 28 are illustrated as circles, however, they may be circles, squares, triangles, rectangles, hexagons, pentagons, polygons and the like. The openings 28 may be formed in any shape desired that allows fluid to easily pass through the face 18 while leaving the face 18 strong enough to withstand the weight and stresses of use.

In FIG. 13, the aggregate replacement 10 units 36 are formed using four faces 18 coupled together at right angles. In alternate embodiments, however, multiple faces 18 may be used. The angle that each face 18 is coupled to the next face 18 depends on the number of faces 18 being used.

Each face 18 is additionally coupled to a proximal end 12 and a distal end 32 in order to form a structure 26. The faces 18 and the proximal end 12 and distal end 32 may be identical or similar and may be interchangeable in certain embodiments.

The proximal end 12 and the distal end 32 are illustrated as square or rectangular members. The shape of the proximal end 12 and the distal end 32, however, will depend on the number of faces 18 used in order to form the structure 26. The proximal end 12 and the distal end 32 may be any size or shape desired. The proximal end 12 and the distal end 32 should, however, provide a cover or substantially close the open ends of the structure 26 formed by the faces 18.

The proximal end 12 and the distal end 32 of each unit 36 may be similar to the at least one face 18 discussed above. The proximal end 12 and distal end 32 may each have at least one opening 28 in its surface in order to allow fluid to easily pass to through the surface of the aggregate replacement 10. The fluid may pass to the inside of the aggregate replacement 10 or to the outside, depending on the desired use of the aggregate replacement 10.

Certain configurations of aggregate replacement 10 units 36 may simply replace large portions of aggregate. These units 36 may be referred to as pipe-less units 52. Pipe-less units 52, as illustrated, have multiple openings 28 on all surfaces. They do not, however, have an opening that would retain or replace a pipe such as a pipe used in a typical drainage field.

Pipe-less units 52 may be any size or shape desired.

Pipe-less units 52 may be coupled to units 36 containing pipe, in order to replace larger areas of aggregate. Multiple pipe-less units 52 may be coupled to units 36 with pipe in order to create large drain fields.

If desired, pipe-less units 52 may also be used in areas where it is desired to drain fluid, but not divert it. Diverting fluid from a given area typically requires some sort of pipe or conduit to direct the fluid. However, if the user simply wants to help a field or yard drain better, pipe-less units 52 may be placed under the surface of the soil in order to give the fluid an area to drain to.

Multiple pipe-less units 52 may also be coupled together.

In alternate embodiments, pipe-less units 52 may be formed from multiple panels, faces or ends which may be coupled together to form the desired shape and size. The multiple panels, faces or ends could also be cut to the desired size in order to allow a user to create custom size pipe-less units 52 for their various applications. Similar configurations could be used for units 36 containing pipe.

As illustrated in FIG. 13, other units 36 may contain a pipe 14. These units 36 are similar to those discussed above with respect to previous figures, except that in the units 36 illustrated in this figure, the pipes 14 are formed as an integral part of the aggregate replacement 10 units 36. The pipes 14 may also be coupled to the aggregate replacement 10 units 36 or may simply be placed in the aggregate replacement 10 units 36, rather than formed as an integral part of the aggregate replacement 10 units 36.

The pipes 14 used in the aggregate replacement 10 will typically be a plastic pipe with perforations 16 formed in it. These perforations 16 allow fluid from the outside of the pipe 14 to seep into the pipe 14. The perforations 16 may be circular holes, linear cuts or the like formed in the pipe 14. The pipe 14 then diverts the fluid such as water to a more desirable location.

In alternate uses, such as septic drainage fields, the perforations 16 in the pipe 14 may allow the fluid inside the pipe 14 to seep out.

The pipe 14 may or may not be corrugated. The pipe 14 may be any size, shape or length desired. The pipe 14 may have a circular, square, rectangular or triangular cross-section or the like. The pipe 14 may be rigid or flexible plastic. The pipe 14 may also be formed from any material desired, such as plastic, fiberglass, iron, copper, steel, aluminum or the like.

The pipes 14 are in communication or coupled to a pipe opening 51 formed in the proximal end 12 and the distal end 32 of each unit 36. The pipe opening 51 is an opening in the proximal end 12 and the distal end 32 of the units 36 that is approximately the same size as the pipe 14 and which secures the pipe 14 in place,

Additional embodiments of aggregate replacement 10 units 36 may include units that act as 90 degree turns, T's, 45 degree turns, and discharges. A 90 degree turn unit 50 is illustrated in the figure. The 90 degree turn unit 50 has a pipe opening 51 in the proximal end 12 of the unit. It also has a pipe opening 51 in one of the faces 18 of the unit 50. This causes the pipe 14 in the 90 degree turn unit 50 to turn 90 degrees within the aggregate replacement 10. This type of unit 50 may be useful in draining water from around concrete foundations and the like.

A T unit 36 in the aggregate replacement 10 would include a pipe opening 51 in the proximal end 12 of the unit 36. Additional pipe openings 51 would be located in two parallel faces 18 located opposite each other in the unit 36. The pipe 14 would start at the proximal end 12 of the aggregate replacement unit 36. The pipe 14 would then split into two pipes 14 with one pipe 14 coupled to each of the pipe openings 51 formed in the faces 18 of the unit 36. In use, fluid would either flow into the unit 36 as one stream and leave the unit 36 as two, or else two streams of fluid would be combined into one stream as it leaves the unit 36.

Other pipe 14 configurations or fittings could be formed in the aggregate replacement 10 units 36 similarly to those described above.

Multiple aggregate replacement 10 units 36 may be coupled together using connectors 34. Connectors 34 may be any type of coupling device or method that allows multiple units 36 to be hooked together. This may include units 36 being coupled with male and female connectors or units being coupled with connectors 34 such as those described in conjunction with FIG. 11. Connectors 34 may be permanent or removable. Removable connectors 34 may be desirable in order to allow damaged aggregate replacement 10 units 36 to be removed and replaced.

Units 36 may be coupled together end to end, such as where the proximal end 12 of one unit 36 is coupled to the distal end 32 of another unit 36, or the units 36 may be coupled or connected side to side or stacked.

In embodiments where a pipe 14 is formed as an integral part of the aggregate replacement 10, it may be desirable to couple the separate pipe 14 sections together as well as the units 36.

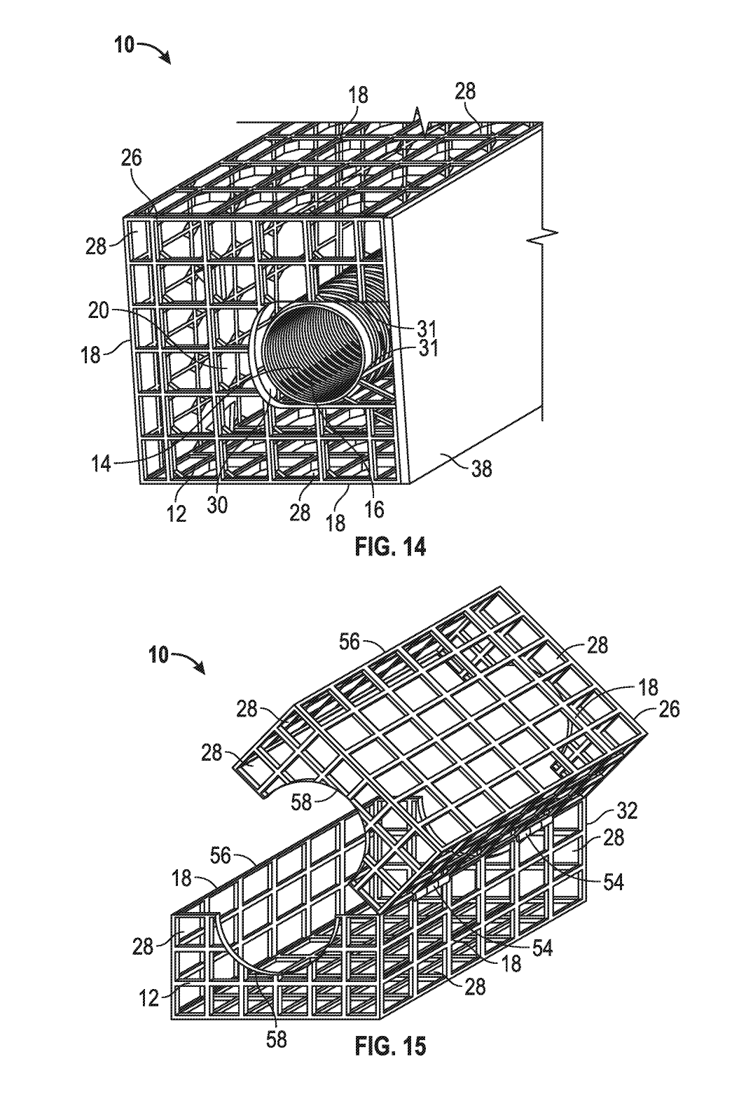

FIG. 14 illustrates an alternate embodiment of FIG. 9. In FIG. 14 the strap 38 covers the entire mouth of the pipe retainer 31. The strap 38 may also cover the entire face 18 of the aggregate replacement 10 in which the mouth of the pipe retainer 31 is located. The strap 38 may be any size, shape, thickness or formed from any material desired. The strap 38 may be corrugated or flat. The strap 38 may also be bent, curved, angled or the like. The strap 38 may be formed from rigid or flexible material.

FIG. 15 illustrates an additional embodiment of an aggregate replacement 10. In this embodiment, the aggregate replacement 10 is formed in two sections 56. Each section 56 has three faces 18 and a proximal end 12 and a distal 32 end. The proximal end 12 and distal end 32 of the aggregate replacement 10 include or comprise a cutout 58. The cutout 58, as shown in the figures, is a half circle opening along the edge of the proximal end 12 and distal end 32 configured to receive a pipe. The cutout 58 may also be any shape desired. The cutout 58 may be horseshoe shaped, square, rectangular, triangular or the like, provided the cutout 58 can accommodate or receive a pipe.

The two sections 56 of the aggregate replacement 10 are coupled together on one side by at least one hinge 54 or other rotatable coupler. Hinge 54 may be anything that rotatable couples the two sections 56 together on one side. Examples of hinges 54 may include hinges, flexible members, tethers, and the like. The other side of the two sections 56 are not connected. Two hinges 54 are illustrated in the figure, however, depending on the size of the aggregate replacement 10, more or fewer hinges 54 may be required.

In order to use the embodiment illustrated in FIG. 15, the two sections 56 are rotated into an open position. A pipe is then placed in the cutout 58 of the lower section 56 of the aggregate replacement 10. Once the pipe is in place, the top section 56 of the aggregate replacement 10 is rotatably lowered into a closed position.

In alternate variations on this embodiment, a latch may be used to keep the two sections 56 of aggregate replacement 10 in a closed position.

Additional embodiments may have multiple sections 56 rather than just two. Latches and hinges 58 could be used to secure the multiple sections 56 together.

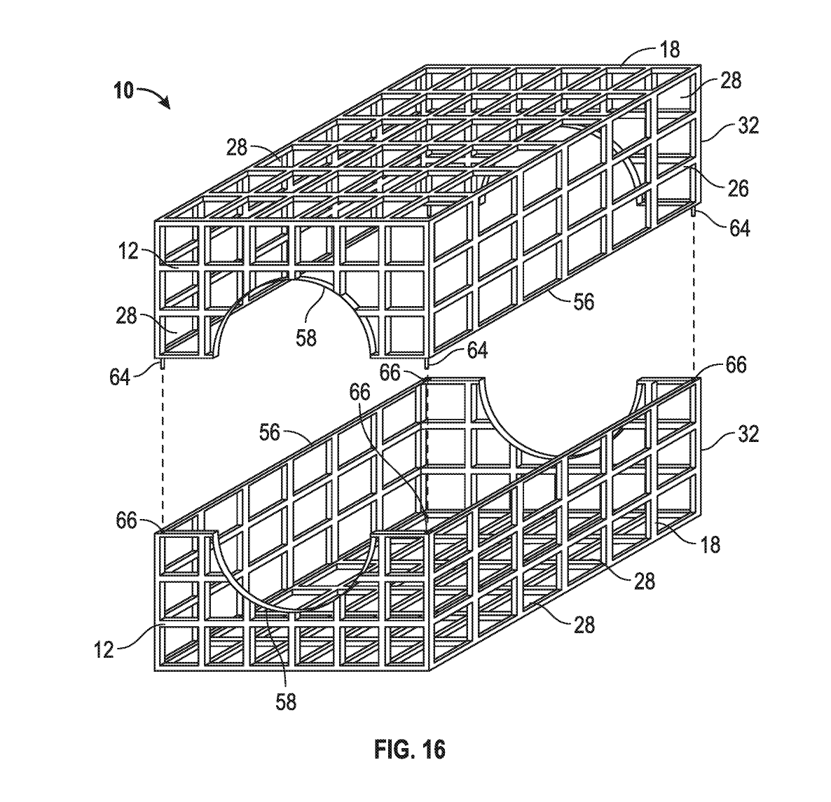

FIG. 16 illustrates an embodiment of an aggregate replacement 10 where the two sections 56 are completely separate. Once the pipe 14 is placed in position in the cutout 58 in the lower section 56 of the aggregate replacement 10, the upper section 56 of the aggregate replacement 10 is put in place. In the alternative, no pipe 14 is required.

The upper section 56 of the aggregate replacement 10 may have pins 64 which are inserted into receivers 66 on the lower section 56 of the aggregate replacement 10 in order to secure or couple the two sections 56 together. The pins 64 slide into receivers 66. The pins 64 are simply cylindrical extensions from the structure 26 of the aggregate replacement 10. The receivers 66 are open cylindrical indentations into the structure 26 of the aggregate replacement 10. The pins 64 and the receivers 66 are close enough in size that by inserting the pin 64 into the receiver 66, the sections 56 are kept reasonably securely connected.

Other coupling or connecting configurations may also be used to secure the two sections 56 together. Other connectors may include glue, epoxy, screws, bolts, tabs, latches or the like.

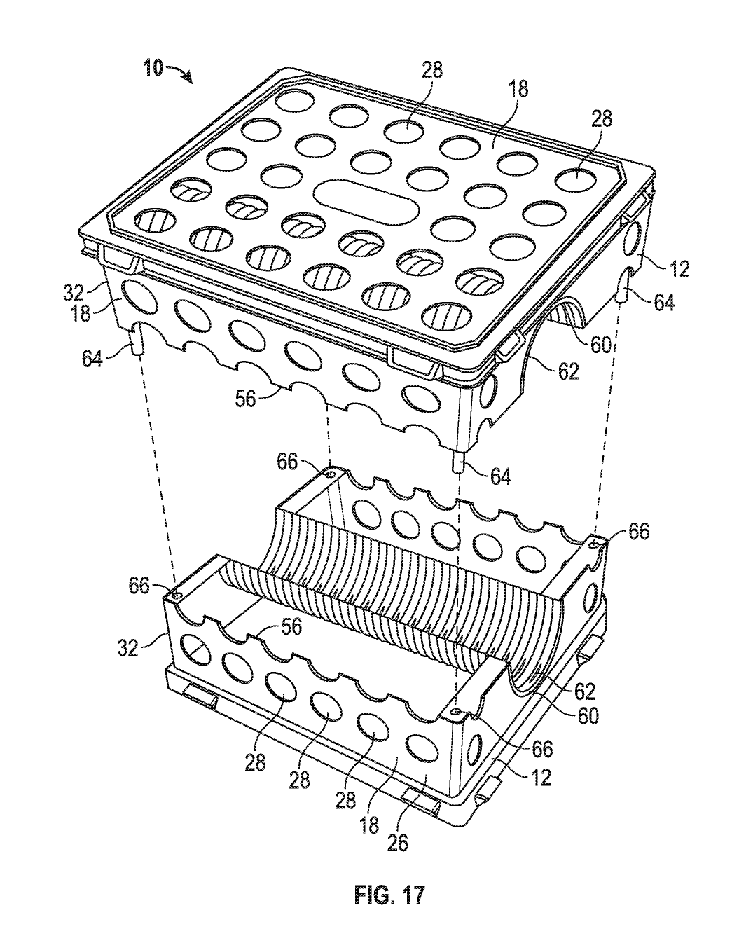

FIG. 17 illustrates an embodiment of an aggregate replacement 10 which has two sections 56 with half pipes 60 formed integrally in each of the sections 56. The half pipe 60 may alternatively be coupled to each of the sections 56. Each half pipe 60 also has perforations 62 in order to allow fluid to move in and out of the pipe 60. The two sections 56 of the aggregate replacement 10 are snapped together using pins 64 and receivers 66 as described in the previous figure. The pins 64 slide into receivers 66. The pins 64 are cylindrical extensions from the structure 26 of the aggregate replacement 10. The receivers 66 are cylindrical openings in the structure 26 of the aggregate replacement 10. The pins 64 and the receivers 66 are close enough in size that by inserting the pin 64 into the receiver 66, the two sections 56 of the aggregate replacement 10 are kept reasonably securely connected.

The two sections 56 may also be coupled together using bolts, screws, glue, epoxy, latches and the like.

When the two sections 56 are coupled together, the two half pipes 60 meet and form a channel or pipe through which water or other fluid may flow.

In alternate configurations of this embodiment, the two half pipes 60 may have connectors, couplers or latches which secure the two half pipes 60 together.

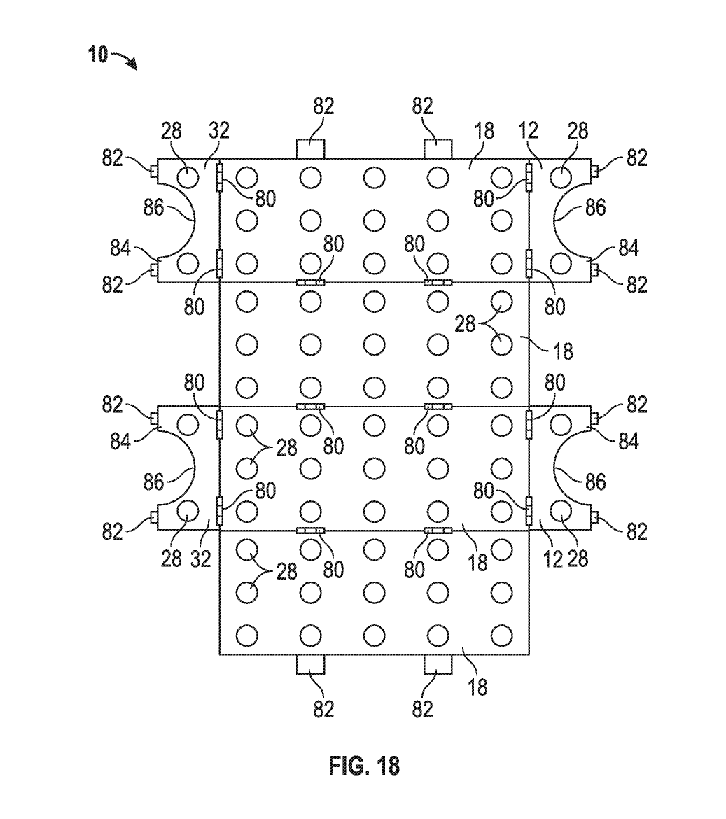

FIG. 18 illustrates a collapsible embodiment of an aggregate replacement 10. In this configuration, each face 18 of the aggregate replacement 10 is hingedly coupled to at least one other face 18 of the aggregate replacement 10.

The two faces 18 on the ends have connectors 82 coupled to their outside edges. These connectors 82 act to hook the two outside faces 18 together in order to form a rectangular prism from all of the faces 18.

In alternate embodiments, one face 18 may be bent and coupled together in order to form a cylindrical aggregate replacement 10. Three faces 18 may be coupled together to form a triangular prism. Different numbers of faces 18 may be used in order to form different shapes of aggregate replacement 10.

Two of the faces 18 are also hingedly coupled to a partial proximal end or distal end 84. The partial ends 84 may be formed as a square with a half circle cutout 86 formed in the edge. The partial ends 84 may also be formed in any other shape desired. The shape of the partial ends 84 will likely depend on the shape created by the faces 18 when they are coupled together.

The partial ends 84 may have at least one connector 82 coupled to at least one of their edges. The at least one connector 82 may serve to secure the partial ends 84 in place when the aggregate replacement 10 is fully assembled.

In order to assemble the collapsible aggregate replacement 10 illustrated, the faces 18 may be coupled together in a rectangular prism using the connectors 82 attached to the two end faces 18. A pipe may then be inserted into the aggregate replacement 10. The partial ends 84 are then rotated and secured into place using the connectors 82 coupled to them.

The partial ends 84 secure the pipe in place in the aggregate replacement 10.

The collapsible aggregate replacement 10 may also be assembled by placing the pipe across at least one face 18 of the aggregate replacement 10. The aggregate replacement 10 is then assembled around the pipe.

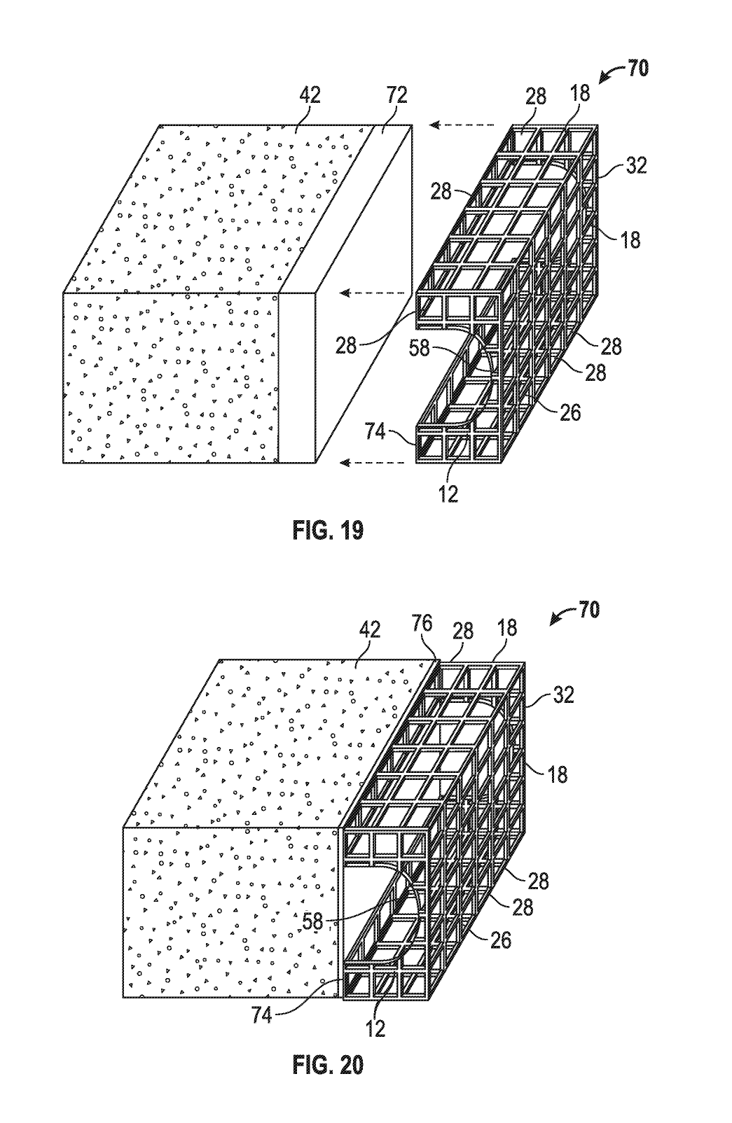

FIG. 19 illustrates a configuration of an aggregate replacement 70 for use with a concrete form. In this configuration, a permanent concrete form 72 such as a form that acts as a drain is put in place. The aggregate replacement 70 is then placed adjacent the concrete form 72. The aggregate replacement 70 acts to replace the aggregate, such as loose gravel, which is placed around permanent concrete forms 72 in order to help the concrete form 72 to drain any water near the concrete 42.

The aggregate replacement 70 in this configuration also has a cutout 58 which intersects the edge of the proximal end 12 and the distal end 32 and which would allow a pipe to be placed next to the permanent concrete form 72 in order to aid with the drainage of water. The cutout 58 or open area may run the entire length of the aggregate replacement 70 along the area where the pipe would be placed, so that the pipe abuts the concrete form 72 directly.

In alternate embodiments, water permeable material may be placed between the aggregate replacement 70 and the concrete form 72. In these configurations, the pipe would abut the water permeable material which would abut the concrete form 72.

In other embodiments, a small section of aggregate replacement 70 may separate the pipe from the concrete form 72 or water permeable material.

Additional embodiments, may not include cutouts 58 for pipe.

FIG. 20 is an additional embodiment of an aggregate replacement 70 for use as a concrete form. In this embodiment, the aggregate replacement 70 is the concrete form. The aggregate replacement 70 is placed into position along the location where the concrete 42 is to be poured. A water permeable material 74 is placed over the surface of the aggregate replacement 70 and then the concrete 42 is poured. The water permeable material 74 prevents the concrete from entering the aggregate replacement 70 while allowing any moisture near the concrete to travel out into the aggregate replacement 70.

The aggregate replacement 70 illustrated in this figure is also configured with a cutout 58 for receiving a pipe. The pipe may be placed before or after the concrete 42 is poured. Typically, however, the pipe will be placed prior to the concrete 42 being poured because it would be too difficult to place the pipe after.

The cutout 58 is formed in the edge of the proximal end 12 and the distal end 32 of the aggregate replacement 70. The cutout 58 also runs along the entire length of the aggregate replacement 70 so that the pipe abuts the water permeable material directly. The pipe acts to collect moisture around the concrete. The pipe then channels the moisture away from the concrete.

In alternate embodiments, a small section of aggregate replacement 70 may separate the pipe from the water permeable material.

Additional embodiments may not include cutouts 58 for a pipe.

In configurations where the aggregate replacement 70 is used as a concrete form or with a concrete form, it may be necessary to secure the aggregate replacement 70 in position by driving a wooden or metal stake through the aggregate replacement 70 and into the ground.

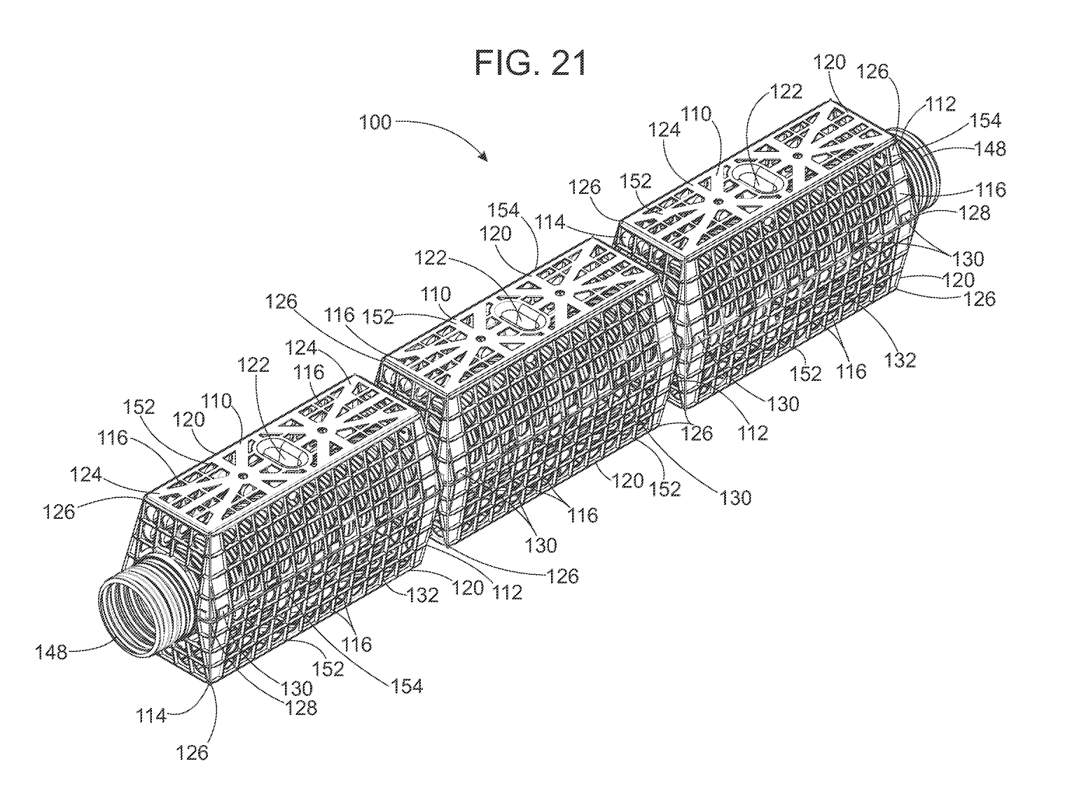

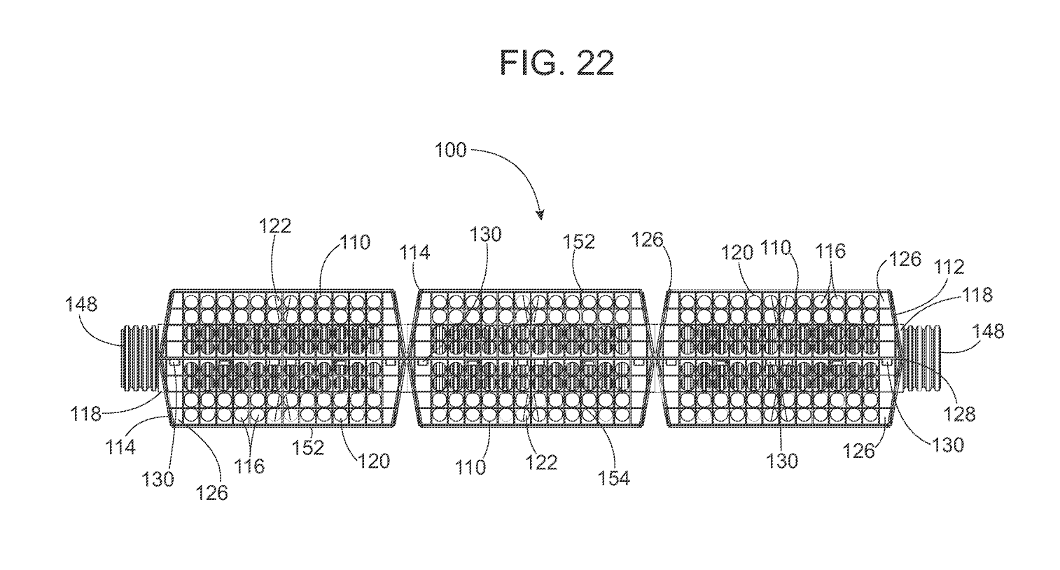

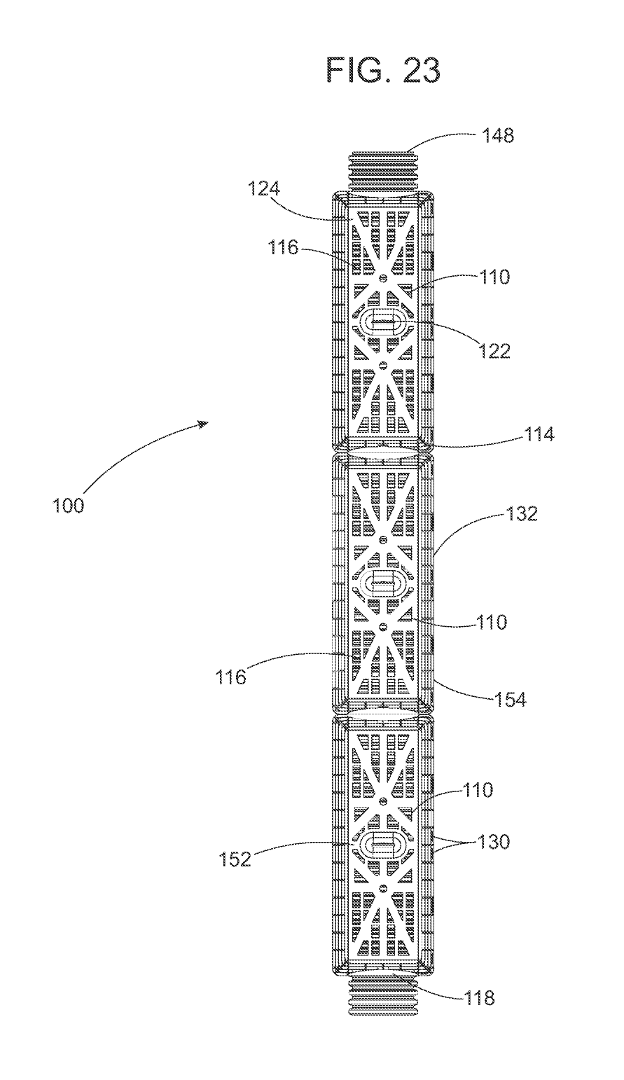

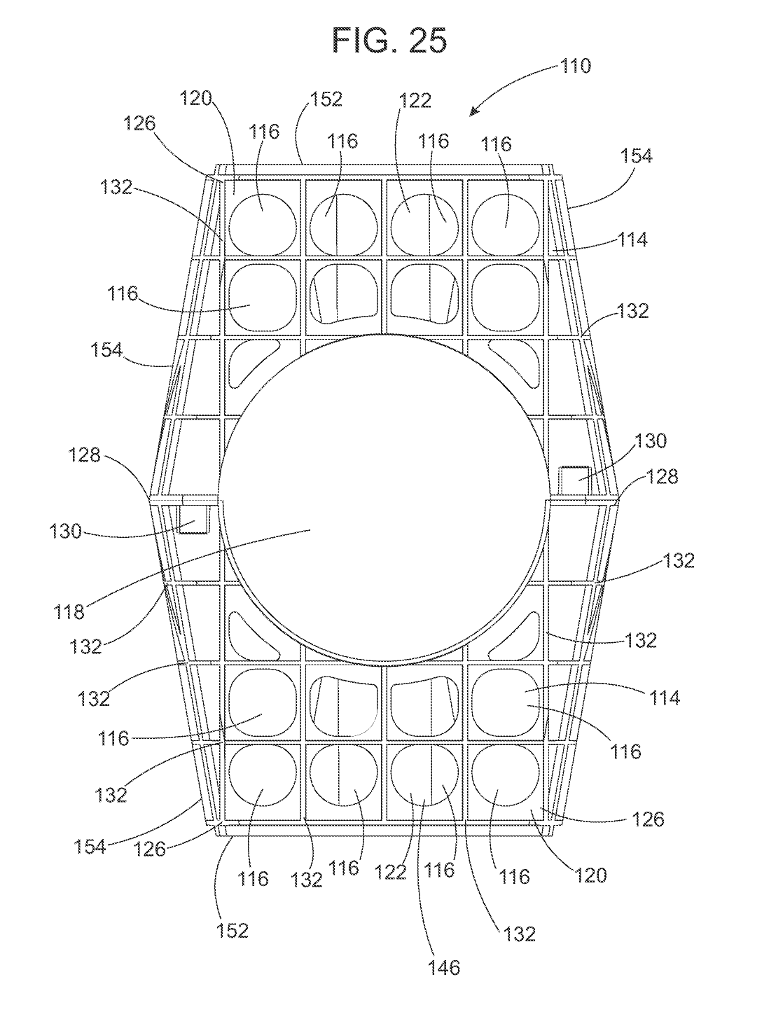

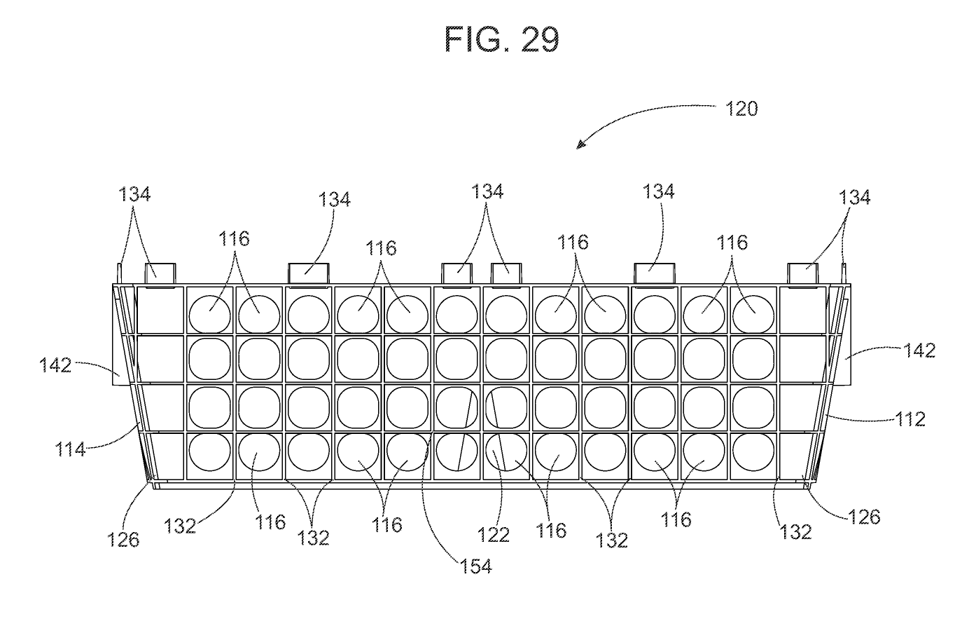

FIGS. 21-30 illustrate an additional embodiment of an aggregate replacement 100. In FIGS. 21-23, the aggregate replacement 100 is illustrated as being formed from multiple aggregate replacement units 110 which are positioned adjacent or abutting one another along a length of pipe 148. Each aggregate replacement unit 110 as illustrated in previous embodiments is a box like structure with a primarily empty interior for moisture to travel through. In addition to the arrangement illustrated in the figures, the units 110 may be spaced out along the length of the pipe 148.

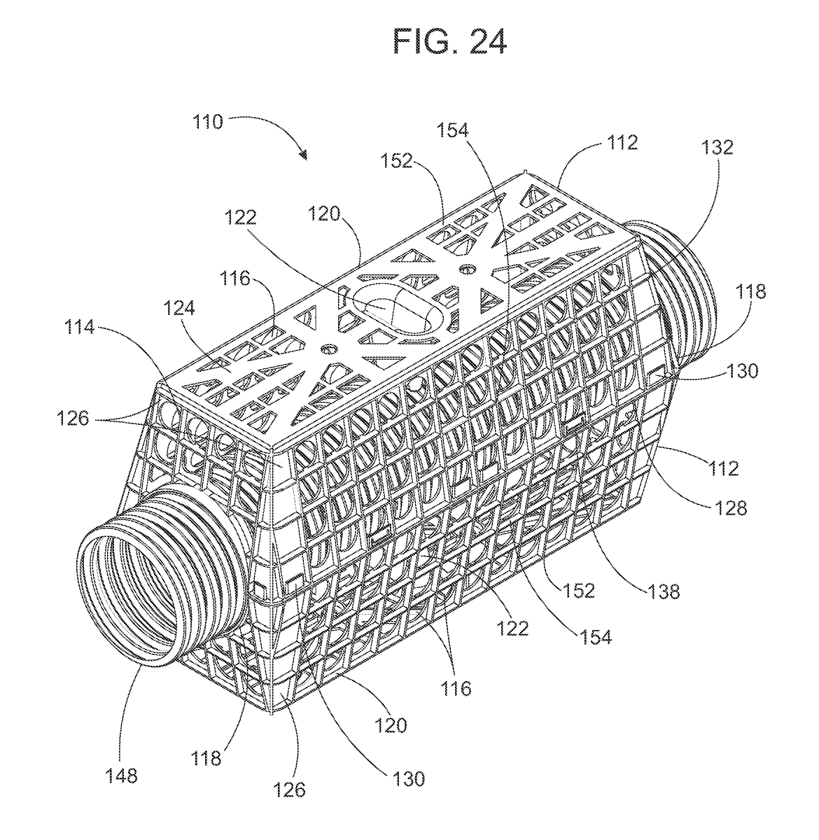

FIGS. 24-26 illustrate a single unit 110 of aggregate replacement. The single unit 110 is illustrated as a closed box with a piece of pipe 148 which passes from one side of the aggregate replacement unit 110 through the interior of the unit 110 and out through the other side. A unit 110 is formed from two sections 120 of aggregate replacement. Each of the sections 120 is a box with an open top. Two or more sections 120, depending on the configuration, are coupled together around a length of perforated pipe 148 in order to form the boxlike unit 110.

Each section 120 of aggregate replacement has a proximal face or end 114 and a distal face or end 112 which are thin straight planar surfaces or faces that are located at each of the ends of the unit 110.

The proximal and distal faces or ends 114 and 112 are thin straight planar surfaces or faces that are used to form the structure or section 120. The proximal and distal faces 114 and 112, as illustrated, are trapezoidal shaped members which are angled slightly from perpendicular with the ground. In previous embodiments, the proximal and distal faces 114 and 112 were square or rectangular, however, in this embodiment the sides of the aggregate replacement sections 120 are angled slightly in order to allow the sections 120 to be stacked for shipping or storage. This angle 126 changes the shape of the proximal and distal faces 114 and 112 from rectangular to trapezoidal.

The proximal and distal faces 114 and 112, as discussed previously, however, may be formed in any shape or size desired. The proximal and distal faces 114 and 112 may be a thin straight planar surface or they may be curved. Additionally the proximal and distal faces 114 and 112 may be formed from a single solid surface or they may have a plurality of openings 116 as illustrated in the figures.

The proximal and distal faces 114 and 112 are both coupled to a bottom face 152. The bottom face 152 could also be considered a top or top face depending on the orientation of the section 120. The bottom face 152 is a rectangular surface that runs the length of the section 120. The bottom face 152 may be a solid planar surface or it may, as illustrated, have multiple openings 116 to allow liquid or moisture to pass through the surface into the interior of the aggregate replacement unit 110.

The bottom face 152 may be rectangular as illustrated or may be round, triangular, square or the like, provided the bottom face 152 serves the purpose of providing support to the remainder of the aggregate replacement unit 110.

At least two other sides 154 are coupled to the bottom face 152 between the proximal face 114 and the distal face 112. The sides 154 are also faces similar to the proximal and distal face 114 and 112 and the bottom face 152. The sides or side faces 154 are illustrated as trapezoidal planar surfaces that are coupled to the proximal face 114 on a proximal side or edge and the distal face 112 on a distal side or edge. The bottom face 152 is coupled to one of the remaining two side edges of the side face 154.

There are at least two side faces 154. One located on each of the lengths of the section 120. The two side faces 154, though illustrated as, trapezoidal surfaces may be rectangular, square, round, triangular or the like. The side faces 154 may be a thin straight planar surface or they may be curved or angled depending on the desire of the user.

A plurality of openings 116 are formed in the proximal face 114, distal face 112, bottom face 152 and side faces 154 of the aggregate replacement section 120. The openings 116 may be circular, triangular, square, trapezoidal, hexagonal, pentagonal or the like or other shaped openings cut or otherwise formed into the surface of the aggregate replacement section 120 in order to allow moisture such as water to travel through the faces of the aggregate replacement section 120 to the interior of the unit 110. The openings 116 may be sized as illustrated or the openings 116 may be smaller and formed as a mesh or the like.

As illustrated, it is likely desirable that the proximal face 114, distal face 112, side faces 154 and bottom face 152 are formed as unitary structures with the openings 116 formed therein.

Additional to the plurality of openings 116 formed in the faces of the aggregate replacement unit 110, strengthening members 124 are coupled to or formed in the bottom face 152 of the section 120. The strengthening members 124 as illustrated are thicker sections of material which are used to increase the strength and durability of the bottom face 152. The bottom face 152 of the unit 110 usually has the weight of soil placed on top of it. Additionally people may walk, drive or the like over the top of the unit 110 once it has been installed, therefore, it is important that the bottom face 152 can withstand the weight of use without collapsing. Additional strengthening members 124 may be used to increase the strength in the bottom face 152 without adding a lot of thickness to the bottom face 152. The strengthening members 124 as illustrated in the figure are formed in a sun shape with a circular member in the middle and other strengthening members 124 radiating out from it. While the illustrated arrangement of strengthening members 124 is an example of a system of strengthening members 124 that can provide the necessary strength to the unit 110, alternative arrangements of the strengthening members 124 also exist.

Additional strengthening members 124 may also be arranged vertically or horizontally along the side faces 154, proximal face 114 and distal face 112.

Other strengthening or raised ribs 132 are also formed in the side faces 154, proximal face 114, distal face 112 and bottom face 152. The raised ribs 132 are thicker sections of material that cross between the openings 116 in the surfaces of the faces. The raised ribs 132 add strength to the side faces 154, proximal face 114, distal face 112 and bottom face 152 of the sections 120 without adding substantial thickness or weight to the unit 110. The raised ribs 132 are illustrated as being organized in a grid shape, however, the raised ribs 132 may be arranged in any shape desired that provides the necessary strength to withstand the stresses of use after installation.

The side faces 154, the distal face 112 and the proximal face 114 are all coupled to the bottom face 152 at an angle other than 90 degrees. The side faces 154, distal face 112 and proximal face 114 are not perpendicular to the bottom face 152 in this embodiment. Instead, the side faces 154, distal face 112 and proximal face 114 are coupled to the bottom face 152 at an obtuse angle 126. The side faces 154, distal face 112 and proximal face 114 are all coupled to the bottom face with a draft angle or an angle beyond perpendicular. This draft angle will likely fall in the range of 3 degrees to 15 degrees making the obtuse angle 126 formed by the side faces 154, distal face 112, and proximal face 114 with the bottom face 152 in the range of 93 degrees to 105 degrees.

The obtuse angle 126 allows sections 120 of aggregate replacement to be stackable within each other. The ability to stack the sections 120 allows for easier and less expensive transportation of the sections 120. Additionally, more sections 120 of the aggregate replacement 100 may be stored in a smaller space, thereby saving money on the storage of excess aggregate replacement 100.

The aggregate replacement section 120 also has a mostly smooth interior surface which also aids in the stacking of the sections 120. The mostly smooth interior surface of the sections 120 prevents the sections 120 from getting caught on each other when they are being stacked or unstacked.

Additionally, the obtuse angles 126 formed between the proximal face 114, distal face 112, side faces 154 and the bottom face 152 cause a fully assembled aggregate replacement unit 110 to have a hexagonal structure. Cross sections of the aggregate replacement unit 110 taken along both the length and the width display the hexagonal structure of the unit 110. This hexagonal structure creates increased strength in the unit 110 causing it to resist many of the forces that will be applied on the unit 110 both during and after installation.

The two sections 120 are coupled together at joint 128. Joint 128 is formed by side edges of the two faces 154 abutting each other. The two sections 120 are coupled together at joint 128 by couplers 130.

Couplers 130 may be any type of coupler desired. Couplers 130 may be male/female connectors, pin connectors, clasps, clamps, screws or the like. Couplers 130 may be any type of couplers 130 that are easy to connect and which make it easy for the two sections 120 to be put into place on top of each other.

When the two sections 120 are coupled as in FIG. 24, an opening 118 is formed in the distal and proximal ends of the aggregate replacement unit 110. The openings 118 are pipe openings configured to contain a perforated pipe 148. The perforated pipe 148 passes through the proximal end of the unit 110, through the interior of the unit 110 and then out through the distal end of the unit 110.

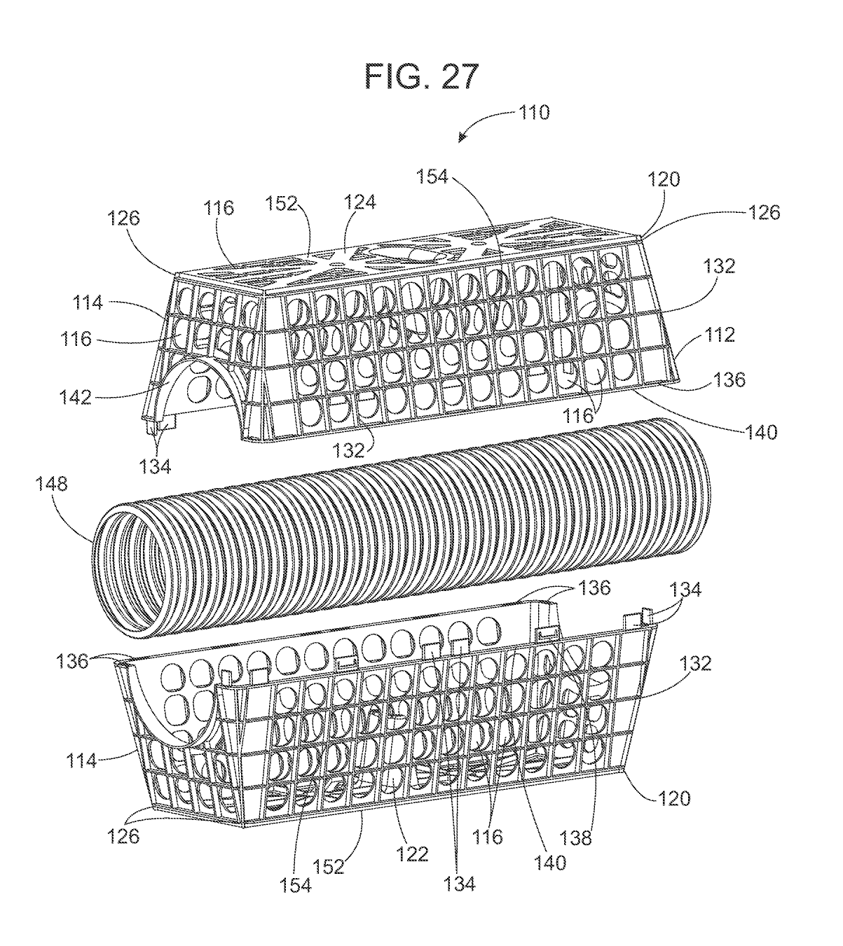

FIG. 27 illustrates an aggregate replacement unit 110 with a pipe 148 installed in an exploded view. In the exploded view, the joint 128 which separated the two sections 120 in the previous depictions is illustrated as two lips or edges 140 of the side faces 154. Both of the side faces 154 and the distal face 112 and proximal face 114 have a lip or edge 140 which when the aggregate replacement unit 110 is assembled abuts the edge 140 of a top or bottom section 120. The edges 140 on the side faces 154, proximal face 114 and distal face 112 are parallel to the bottom face 152 of the section 120. Due to the fact that the side faces 154, proximal face 114 and distal face 112 are coupled to the bottom face 152 at an angle greater than perpendicular or an obtuse angle 126, the edge 140 must be formed at angle in order to be parallel to the bottom face 152. Therefore, the edges 140 of the side faces 154, proximal face 114 and distal face 112 are not perpendicular to the surface of the respective faces.

Along the edge 140 of the side faces 154, proximal face 114 and distal face 112, the couplers 130 are illustrated as separate male 134 and female 136 members. The male member 134 is mated with the female member 136 in order to couple the two sections 120 together. The male members 134 are illustrated as tabs extending from half of the edge 140 of the section 120. The other half of the edge of the section 120 has female members 136 formed in it. This allows two identical sections 120 to be mated by flipping them so that the open surface of each section 120 abuts.

The male coupling member 134 though illustrated as a tab may be a pin, extrusion or the like.

The female coupling member 136 is illustrated as a slot formed in or along the edge 140 of half of the section 120. The female coupling member 136 is configured to be receive the male coupling member 134 when the two sections 120 abut.

While a male coupling member 134 and female coupling member 136 are illustrated in the figures, any type of coupling system that allows the two sections 120 of the unit 110 to be coupled together for installation may be used.

In addition to the coupling system, a locking mechanism 138 is illustrated. The locking mechanism 138 is illustrated as a raised area on some of the male coupling members 134. The locking mechanism 138 may be a slightly raised wedge shape of material, which when inserted into the female coupling member 136 catches on a lip in or under the female coupling member 136 thereby preventing the male coupling member 134 from being unintentionally removed from the female coupling member 136 and thereby locking the two sections 120 together. The locking mechanism 138 may also be a protrusion of any shape or size desired.

Alternate embodiments of a locking mechanism 138 may include a latching member that fits over a lip on both sections 120 of the unit 110. Other embodiments could include a screw or bolt which is secured through both sections 120 of the unit 110 or the like.

The edge 140 on the section 120 of aggregate replacement surrounds a mating opening 150. This opening 150 coincides with an identical opening 150 in another section 120 of aggregate replacement. When two mating openings 150 on two different sections 120 are placed in abutment, a unit 110 of aggregate replacement is formed which allows fluid to freely flow from one section 120 to the other.

An additional opening or cutout in the distal face 112 and proximal face 114 of the section 120 is configured to receive a section of pipe 148. The pipe cutout 142 is a semi-circle formed in the proximal face 114 and distal face 112 of a section 120. When two sections 120 are coupled together, the pipe cutouts 142 form a circular opening through which the pipe 148 passes.

Prior to coupling the two sections 120 together, the pipe 148 is placed in the pipe cutouts 142 of one section 120. Then the second section 120 is placed on top of the pipe 148.

The pipe cutout 142 may simply be a cutout or opening formed in the proximal face 114 and distal face 112 of the section 120 or the pipe cutout 142 may have a lip as illustrated. The lip may provide added strength to the unit 110 and additional support to the pipe 148.

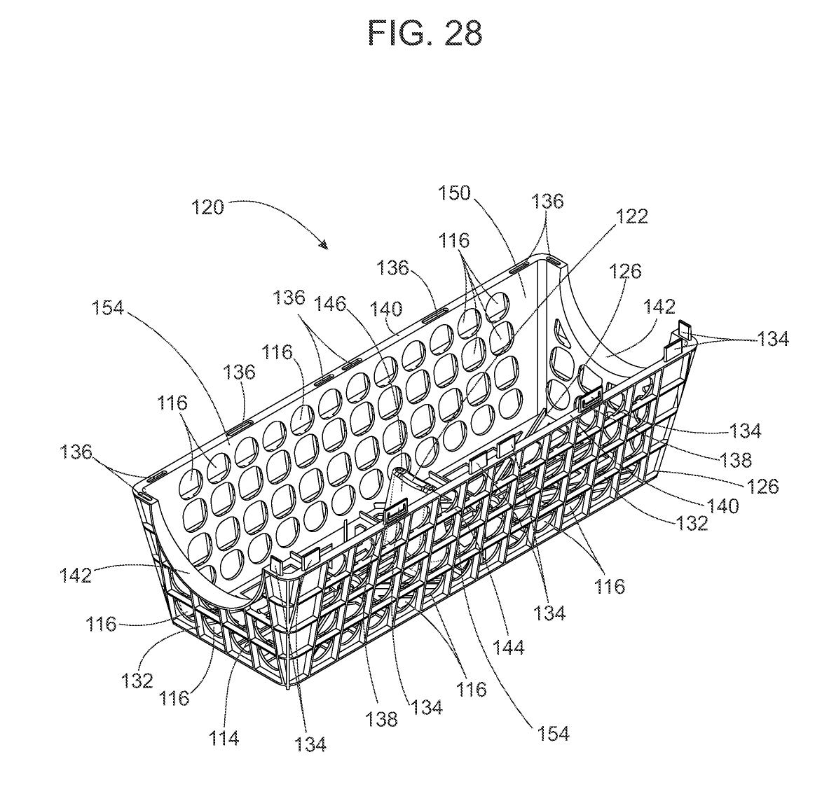

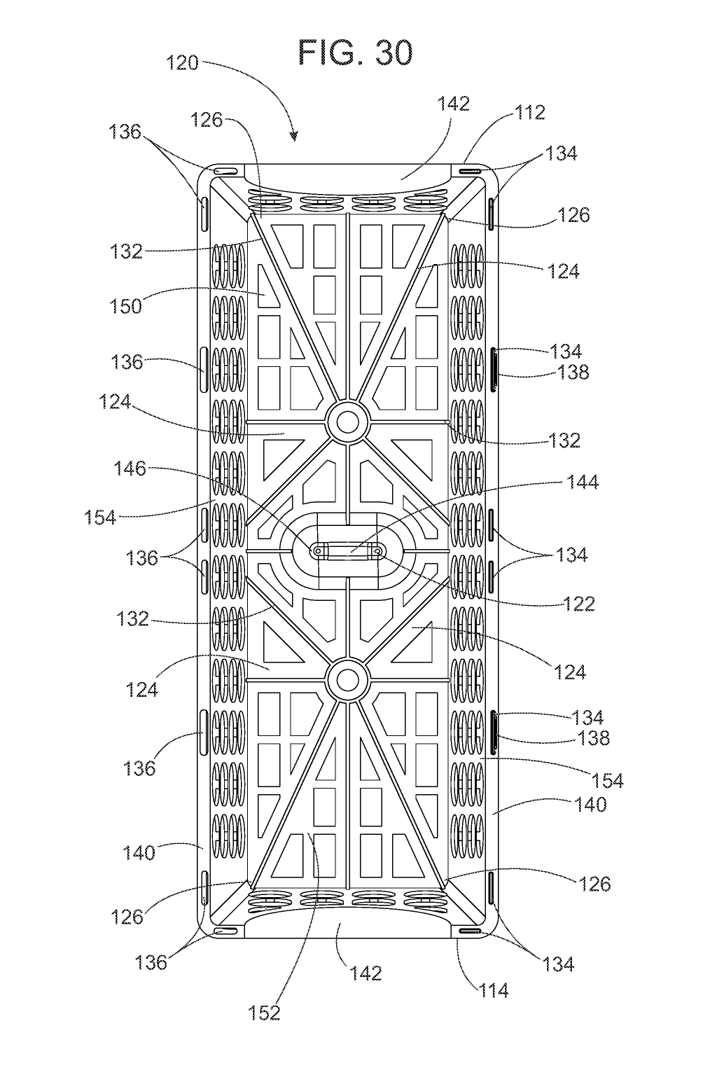

FIGS. 28-30 illustrate views of a section 120 of an aggregate replacement unit 110. In FIGS. 28 and 30 in particular, the interior of the section 120 is visible. A pipe support 122 is coupled in the center or a centrical location on the bottom face 152 of the section 120 opposite the mating opening 150. The pipe support 122 is a protrusion that extends from the bottom face 152 of the section 120 to provide added support to the pipe 148 to prevent it from sagging or the like. The pipe support 122 includes a support member 146. The support member 146 extends from the bottom face 152 to a support surface 144 which is a curved surface that abuts a portion of the pipe 148.

The support member 146, as illustrated, is a hollow member that tapers as it approaches the support surface. The support member 146 should be tall enough to support the pipe 148 in a mostly horizontal position. By forming the support member 146 as a hollow tapered protrusion, a support member 146 on a second section 120 may be inserted into the bottom underside of the support member 146 when the sections 120 are stacked.

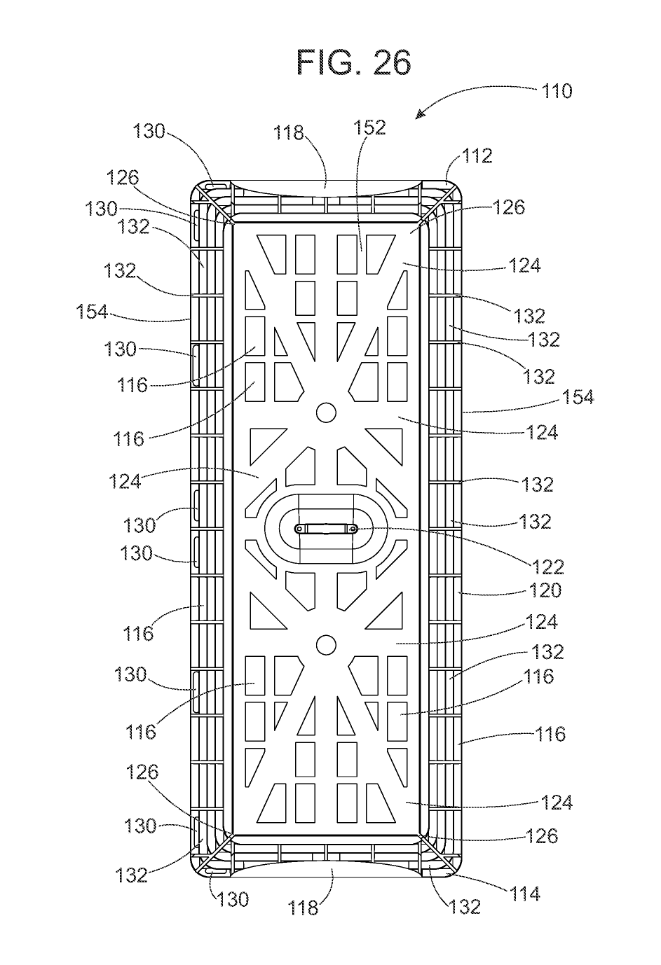

FIG. 26, which is a top view of a section, or a view from the underside of the bottom face 152, illustrates the underside of the pipe support 122. The hollow interior of the pipe support 122 is illustrated. When multiple sections 120 are stacked for storage the pipe supports 122 on each succeeding section 120 fits inside the pipe support 122 on the previous section 120, thereby allowing the sections 120 to be stacked more compactly than if a solid pipe support 122 was used.

FIG. 28 illustrates the support surface 144 which is a slightly curved top to the pipe support 122. The support surface 144 is configured to provide support to the pipe 148 while taking up very little room and contacting a fraction of the surface of the diameter of the pipe 148. In some configurations, the support surface 144 may contact fifty percent or less of the surface of the diameter of the pipe 148. In other configurations, the support surface 144 may contact less than a third or thirty-three percent of the surface of the diameter of the pipe 148, thereby allowing the pipe support 122 to take up very little space within the unit 110.

Due to the fact that both sections 120 of the unit 110 are identical, a pipe support 122 will be located both above and below the pipe 148 in a unit 110. While the lower pipe support 122 helps to support the pipe 148, the upper pipe support 122 helps to support the top or upper bottom surface 152 of the unit 110, thereby providing added strength and stability to the entire unit 110.

In alternate embodiments, however, a solid or non-hollow pipe support 122 may be used instead of the hollow pipe support 122 illustrated. When a solid pipe support 122 is used the stacked sections 120 will have an empty space between each section 120 for the pipe support 122. Therefore, sections 120 with a solid pipe support 122 cannot be stacked as tightly as sections 120 with a hollow pipe support 122 as illustrated.

When in use the aggregate replacement 100 is installed similarly to FIG. 21. First a trench is excavated. The trench is lined with filter fabric. Then a row of sections 120 of aggregate replacement 100 are placed in the bottom of the trench with the mating opening 150 facing up. The sections 120 may be placed abutting each other or they may be spaced out. A pipe 184 is then placed in the pipe cutouts 142 in the distal face 112 and proximal face 114 of the section 120. The pipe 184 is also placed on the pipe support 122. Other sections 120 are then coupled and locked into position on top of the sections 120 in the trench. The top sections 120 are flipped over so that the mating openings 150 on the top sections 120 are adjacent the mating openings 150 on the bottom sections 120. Once the aggregate replacement 100 has been assembled, the filter fabric is wrapped around the aggregate replacement and the trench is filled in with dirt.

Additional embodiments of the aggregate replacement may be used as a radon evacuation system. In embodiments configured for radon evacuation, an additional upward means connects the aggregate replacement to a conduit for discharge of the radon gas into the air away from any structures.

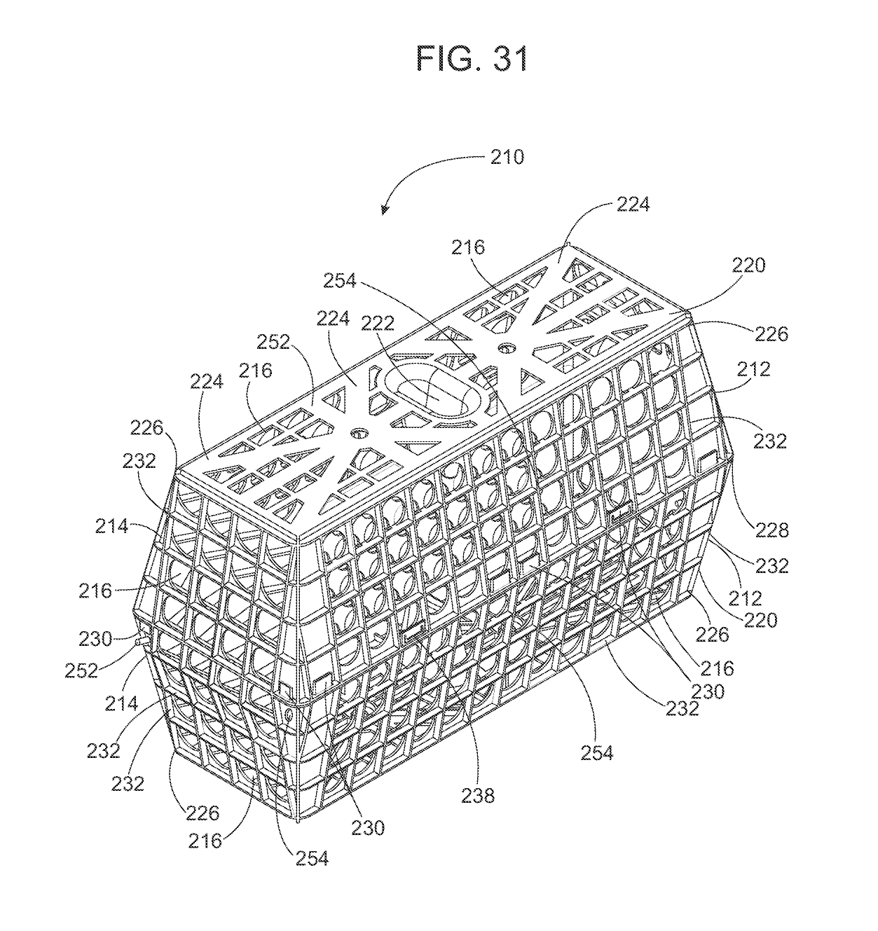

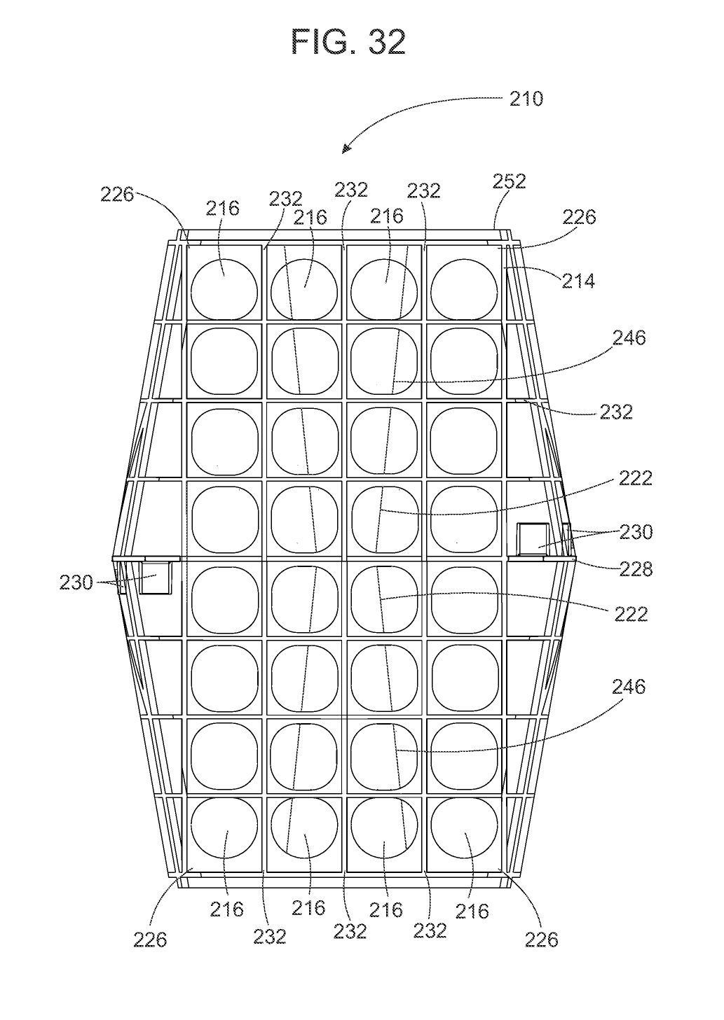

FIGS. 31-33 illustrate a pipe-less unit configured similarly to the embodiment just disclosed. The pipe-less unit 210 is also illustrated as a closed box. A pipe-less unit 210 is formed from two sections 220 of pipe-less aggregate replacement. Each of the sections 220 is a box with an open top. Two or more sections 220, depending on the configuration, are snapped or coupled together in order to form the boxlike unit 210.

Each section 220 of pipe-less aggregate replacement has a proximal face or end 214 and a distal face or end 212 which are thin planar surfaces or faces that are located at each of the ends of the section 220.

The proximal and distal faces or ends 214 and 212 are thin planar surfaces or faces that are used to form the structure or section 220. The proximal and distal faces 214 and 212, as illustrated, are trapezoidal shaped members which are angled slightly from perpendicular with the ground. In previous embodiments, the proximal and distal faces 214 and 212 were square or rectangular, however, in this embodiment the sides of the aggregate replacement sections 220 are angled slightly in order to allow the sections 220 to be stacked for shipping or storage. This angle 226 changes the shape of the proximal and distal faces 214 and 212 from rectangular to trapezoidal.

The proximal and distal faces 214 and 212, as discussed previously, however, may be formed in any shape or size desired. The proximal and distal faces 214 and 212 may be thin straight planar surfaces or they may be curved. Additionally the proximal and distal faces 214 and 212 may be formed from a single solid surface or it may have a plurality of openings 216 as illustrated in the figures.

The proximal and distal faces 214 and 212 are both coupled to a bottom face 252. The bottom face 252 could also be considered a top or top face depending on the orientation of the section 220. The bottom face 252 is a rectangular surface that runs the length of the section 220. The bottom face 252 may be a solid planar surface or it may, as illustrated, have multiple openings 216 to allow liquid or moisture to pass through the surface into the interior of the pipe-less aggregate replacement unit 210.

The bottom face 252 may be rectangular as illustrated or may be round, triangular, square or the like, provided the bottom face 252 serves the purpose of providing support to the remainder of the pipe-less aggregate replacement unit 210.

At least two other sides 254 are coupled to the bottom face 252 between the proximal face 214 and the distal face 212. The sides 254 are also faces similar to the proximal and distal face 214 and 212 and the bottom face 252. The sides or side faces 254 are illustrated as trapezoidal planar surfaces that are coupled to the proximal face 214 on a proximal side or edge and the distal face 212 on a distal side or edge. The bottom face 252 is coupled to one of the remaining two side edges of the side face 254.

There are at least two side faces 254. One located on each of the lengths of the section 220. The two side faces 254, though illustrated as, trapezoidal surfaces may be rectangular, square, round, triangular or the like. The side faces 254 may be thin straight planar surfaces, curved or angled depending on the desire of the user.

A plurality of openings 216 are formed in the proximal face 214, distal face 212, bottom face 252 and side faces 254 of the pipe-less aggregate replacement section 220. The openings 216 may be circular, triangular, square, trapezoidal, hexagonal, pentagonal or the like or other shaped openings cut or otherwise formed into the surface of the aggregate replacement section 220 in order to allow moisture such as water to travel through the faces of the pipe-less aggregate replacement section 220 to the interior of the unit 210. The openings 216 may be formed in any size desired. The openings 216 may be sized as illustrated in the figures or the openings 216 in a smaller mesh-like configuration.

As illustrated, it is likely desirable that the proximal face 214, distal face 212, side faces 254 and bottom face 252 are formed as unitary structures with the openings 216 formed therein.

Additional to the plurality of openings 216 formed in the faces of the pipe-less aggregate replacement unit 210, strengthening members 224 are coupled to or formed in the bottom face 252 of the section 220. The strengthening members 224 as illustrated are thicker sections of material which are used to increase the strength and durability of the bottom face 252. The bottom face 252 of the unit 210 usually has the weight of soil placed on top of it. Additionally people may walk, drive or the like over the top of the unit 210 once it has been installed, therefore, it is important that the bottom face 252 can withstand the weight of use without collapsing. Therefore additional strengthening members 224 may be used to increase the strength in the bottom face 252 without adding substantial thickness to the bottom face 252. The strengthening members 224 as illustrated in the figure are formed in a sun shape with a circular member in the middle and other strengthening members 224 radiating out from it. While the illustrated arrangement of strengthening members 224 is an example of a system of strengthening members 224 that can provide the necessary strength to the unit 110, alternative arrangements of the strengthening members 224 also exist.

Additional strengthening members 224 may also be arranged vertically or on the side faces 254, proximal face 214 and distal face 212.

Other strengthening or raised ribs 232 are also formed in the side faces 254, bottom face 252, proximal face 214 and distal face 212. The raised ribs 232 are thicker sections of material that cross between the openings 216 in the surfaces of the faces. The raised ribs 232 add strength to the side faces 254, bottom face 252, proximal face 214 and distal face 212 of the sections 220 without adding substantial thickness or weight to the unit 210. The raised ribs 232 are illustrated as being organized in a grid shape, however, the raised ribs 232 may be arranged in any shape desired that provides the necessary strength to withstand the stresses of use after installation.

The side faces 254, the distal face 212 and the proximal face 214 are all coupled to the bottom face 252 at an angle other than 90 degrees. The side faces 254, distal face 212 and proximal face 214 are not perpendicular to the bottom face 252 in this embodiment. Instead, the side faces 254, distal face 212 and proximal face 214 are coupled to the bottom face 252 at an obtuse angle 226. The side faces 254, distal face 212 and proximal face 214 are all coupled to the bottom face at a draft angle or an angle beyond perpendicular. This draft angle will likely fall in the range of 3 degrees to 15 degrees making the obtuse angle 226 formed by the side faces 254, distal face 212, and proximal face 214 with the bottom face 252 in the range of 93 degrees to 105 degrees.

The obtuse angle 226 allows sections 220 of pipe-less aggregate replacement to be stackable within each other. The ability to stack the sections 220 allows for easier and less expensive transportation of the sections 220. Additionally, more sections 220 of the pipe-less aggregate replacement may be stored in a smaller space, thereby saving money on the storage of excess aggregate replacement.

The aggregate replacement section 220 also has a mostly smooth interior surface which also aids in the stacking of the sections 220. The mostly smooth interior surface of the sections 220 prevents the sections 220 from getting caught on each other when they are being stacked or unstacked.

Additionally, the obtuse angles 226 formed between the proximal face 214, distal face 212, side faces 254 and the bottom face 252 cause a fully assembled aggregate replacement unit 210 to have a hexagonal structure. Cross sections of the aggregate replacement unit 210 taken along both the length and the width display the hexagonal structure of the unit 210. This hexagonal structure creates increased strength in the unit 210 causing it to resist many of the forces that will be applied on the unit 210 both during and after installation.

The two sections 220 are coupled together at joint 228. Joint 228 is formed by side edges of the two faces 254 abutting each other. The two sections 220 are coupled together at joint 228 by couplers 230.

Couplers 230 may be any type of coupler desired. Couplers 230 may be male/female connectors, pin connectors, clasps, screws or the like. Provided the couplers 230 are easy to connect and make it easy for the two sections 220 to be put into place on top of each other.

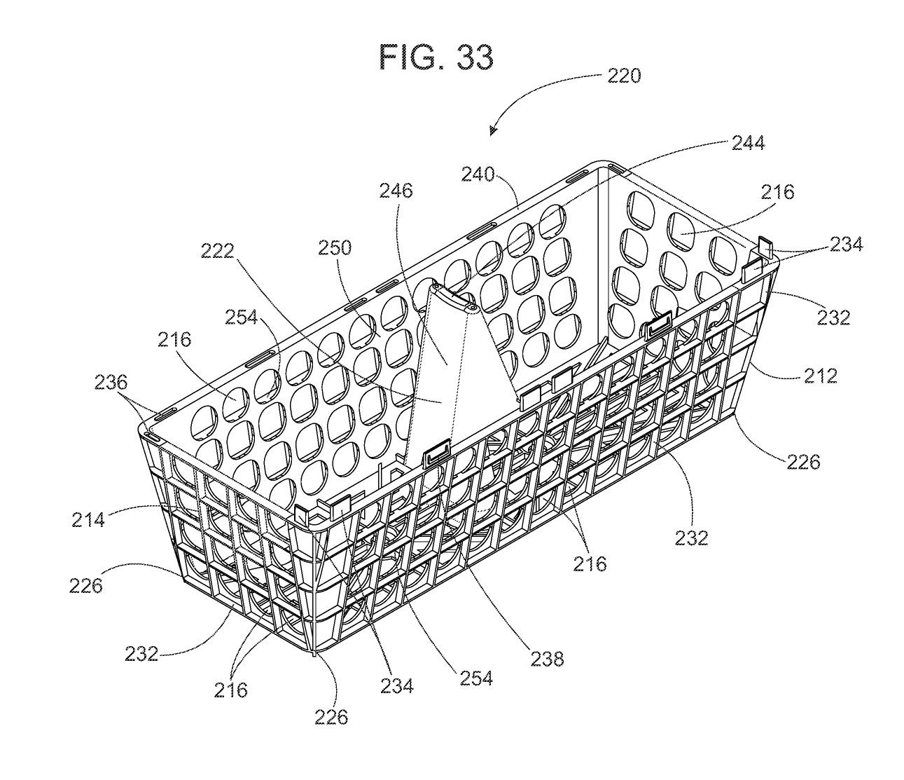

In FIG. 33, the joint 228 which separated the two sections 220 in the previous depictions is illustrated as a lip or edge of the side faces 254. Both of the side faces 254 and the distal face 212 and proximal face 214 have a lip or edge 240 which when the pipe-less aggregate replacement unit 210 is assembled abuts the edge 240 of a top of bottom section 220. The edge 240 on the side faces 254, proximal face 214 and distal face 212 are parallel to the bottom face 252 of the section 220. Due to the fact that the side faces 254, proximal face 214 and distal face 212 are coupled to the bottom face 252 at an angle greater than perpendicular or an obtuse angle 226, the edge 240 must be formed at angle in order to be parallel to the bottom face 252. Therefore, the edge 240 of the side faces 254, proximal face 214 and distal face 212 are not perpendicular to the surface of the respective faces.

Along the edge 240 of the side faces 254, proximal face 214 and distal face 212, the couplers 230 are illustrated as separate male 234 and female 236 members in this figure. The male member 234 is mated with the female member 236 in order to couple the two sections 220 together. The male members 234 are illustrated as tabs extending from half of the edge 240 of the section 220. The other half of the edge of the section 220 has female members 236 formed in it. This allows two identical sections 220 to be mated by flipping them so that the open surface of each section 220 abuts.

The male coupling member 234 though illustrated as a tab may be a pin, extrusion or the like.

The female coupling member 236 is illustrated as a slot formed in or along the edge 240 of half of the section 220. The female coupling member 236 is configured to be receive the male coupling member 234 when the two sections 220 abut. The female coupling member 236 may also be formed in any size or shape desired, provided it serves the purpose to couple the two sections 220 of pipe-less aggregate replacement together.

While a male coupling member 234 and female coupling member 236 are illustrated in the figures, any type of coupling system that allows the two sections 220 of the unit 210 to be coupled together for installation may be used.

In addition to the coupling system, a locking mechanism 238 is illustrated. The locking mechanism 238 is illustrated as a raised area on some of the male coupling members 234. The locking mechanism 238 may be a slightly raised wedge shape of material, which when inserted into the female coupling member 236 catches on a lip in or under the female coupling member 236 thereby preventing the male coupling member 234 from being unintentionally removed from the female coupling member 236 and thereby locking the two sections 220 together. The locking mechanism 238 may also be a protrusion of any shape or size desired.

Alternate embodiments of a locking mechanism 238 may include a latching member that fits over a lip on both sections 220 of the unit 210. Other embodiments could include a screw or bolt which is secured through both sections 220 of the unit 210 or the like.

The edge 240 on the section 220 of pipe-less aggregate replacement surrounds a mating opening 250. This opening 250 coincides with an identical opening 250 in another section 220 of pipe-less aggregate replacement. When two mating openings 250 on two different sections 220 are placed in abutment, a unit 210 of pipe-less aggregate replacement is formed which allows fluid to freely flow from one section 220 to the other.

FIG. 33 illustrates an isometric view of a section 220 of a pipe-less aggregate replacement unit 210. In FIG. 33 the interior of the section 220 is visible. A support 222 is coupled in the center or a centrical location on the bottom face 252 of the section 220 opposite the mating opening 250. The support 222 is a protrusion that extends from the bottom face 252 of the section 220 to provide added support to the unit 210 to prevent it from sagging or the like. The support 222 includes a support member 246. The support member 246 extends from the bottom face 252 to a support surface 244 which abuts the support surface 244 of the support 222 in the section 220 which is positioned above or below the support surface 244. The supports 222 in the two sections 220 which are coupled together to form the unit 210 are positioned abutting or adjacent each other when the sections 220 are coupled together. The supports 220 add strength and support to the unit 210 and help to prevent it from collapsing when in use.

The support member 246, as illustrated, is a hollow member that tapers as it approaches the support surface 244. The support member 246 is as tall or almost as tall as the edge of the pipe-less aggregate replacement section 220. By forming the support member 246 as a hollow tapered protrusion, a support member 246 on a second section 220 may be inserted into the bottom underside of the support member 246 when the sections 220 are stacked for storage or shipping.

FIG. 31, which is an isometric view of a pipe-less unit 210, illustrates the underside of the support 222. The hollow interior of the support 222 is illustrated. When multiple sections 220 are stacked for storage the supports 222 on each succeeding section 220 fits inside the support 222 on the previous section 220, thereby allowing the sections 220 to be stacked more compactly than if a solid support 222 was used.

In alternate embodiments, however, a solid support 222 may be used instead of the hollow support 222 illustrated. When a solid support 222 is used the stacked sections 220 will have an empty space between each section 220 for the support 222. Therefore, sections 220 with a solid support 222 cannot be stacked as tightly as sections 220 with a hollow support 222 as illustrated.

In additional embodiments, pipe-less aggregate replacement units 210 may have couplers on the distal face 212 and proximal face 214 of the unit 210 in order to couple multiple units 210 together as the pipe-less units 210 do not have the pipe to hold them in place horizontally. FIG. 31 illustrates a male coupler 252 and a female coupler 254 formed or coupled to the proximal face 214 of the pipe-less aggregate unit 210. A similar arrangement of couplers would be formed on the distal face 212 allowing two pipe-less aggregate units 210 to be coupled adjacent each other.

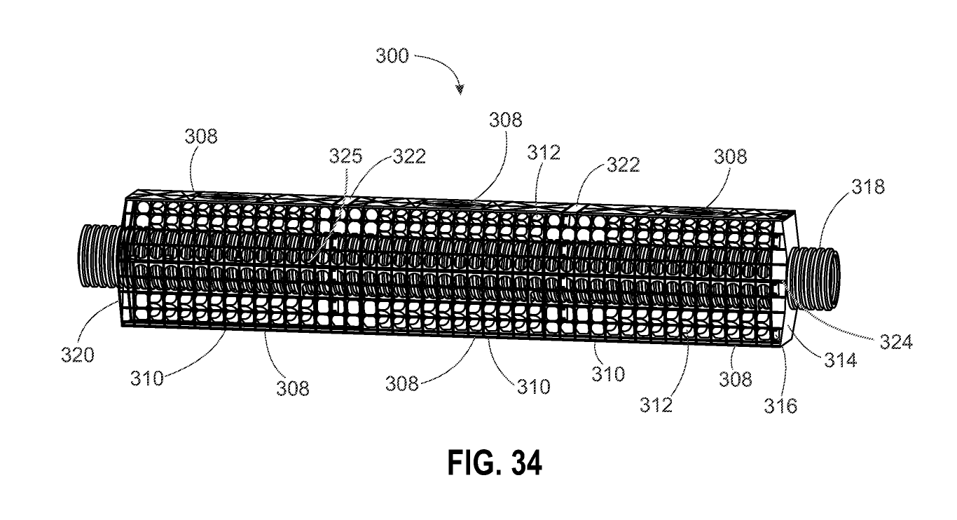

FIG. 34-36 disclose an open ended embodiment of an aggregate replacement 300. The open ended aggregate replacement 300 includes a plurality of open ended units 310. The open ended units 310 are aggregate replacement units 310 similar to those disclosed above, however, at least the proximal or distal end of the unit is open.

FIG. 34 illustrates an aggregate replacement 300 with a plurality of units 310 positioned adjacent one another. Each unit 310 is formed from at least two sections 308. Typically, a unit 310 is formed from a top section 308 and a bottom section 308.

The top section and bottom section 308 are placed adjacent each other at seam 324. The two sections 308 are positioned so that a lateral opening on each section 308 abuts a lateral opening on the other section 308. These openings create an open interior in the unit 310.

Seam 324 is locked together with couplers 325. Couplers 325 may be any type of coupler that secures the two sections 308 together. Couplers 325 may be male/female connectors, tabs and slots, latches, clips, pins and receivers and the like. Couplers 325 may removably, lockably or permanently couple the two sections 308 together.

The sections 308 are formed from a plurality of faces as disclosed in previous embodiments. The faces each have a plurality of openings 312 formed in them. The openings 312 allow fluids such as water to travel from the outside of the aggregate replacement 300 to the inside of the aggregate replacement 300. This allows water to travel from the soil surrounding the aggregate replacement 300 to the interior of the aggregate replacement 300 and from there into the perforated pipe 318 which is illustrated passing through the interior of the aggregate replacement 300. The perforations in the pipe 318 allow the water to pass to the interior of the pipe 318 which then drains the water to a more preferable location.

Unlike the embodiments illustrated previously, the units 310 of this embodiment have open ends 320 at both the distal and proximal ends. Alternatively, the units 310 may only have one open end 320. The open ends 320 are simply an absence of a distal or proximal face.

The aggregate replacement 300, as illustrated, is formed from multiple units 310 which abut one another at seams 322. These seams 322 are where an open distal end and an open proximal end meet.

The open ends 320 may latch together using couplers 316. Couplers 316 may be any type of coupler that mates the two units 310 together. Couplers 316 may include male/female connectors, pins and receivers, tabs and slots, latches, clips, or the like. Couplers 316 may removably, lockably or permanently couple the two units 310 together.

While the open ends 320 on the aggregate replacement 300 may be left open. End caps 314 may be coupled to the open ends 320 of the aggregate replacement 300. The end caps 314 as illustrated are simply a face which fits around the pipe 318 and which couples to the open end 320 through additional couplers 316.

The end cap 314 may be a solid piece as illustrated in FIG. 34 or it may have a plurality of openings like the faces of the sections 308.

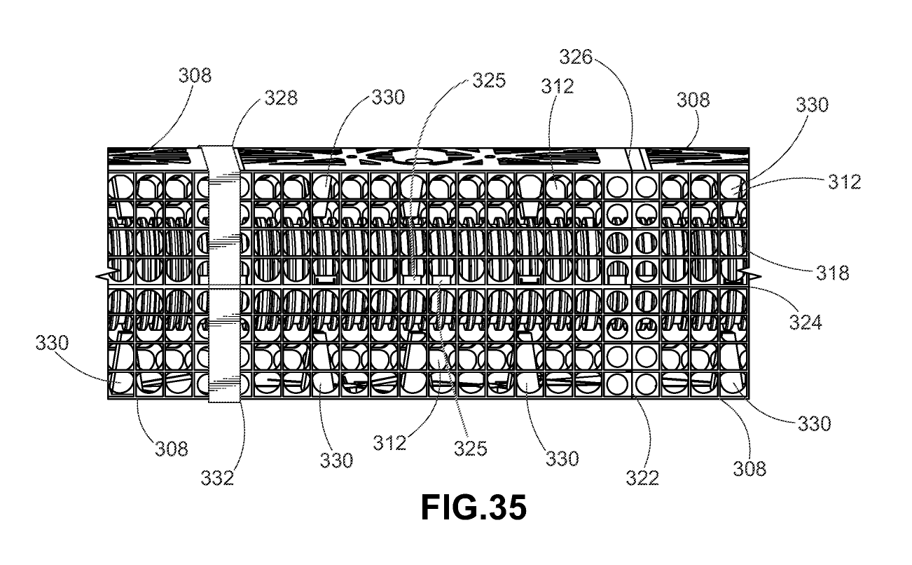

FIG. 35 illustrates alternate methods of coupling multiple units 310 together in order to create an aggregate replacement 300.

Multiple units 310 may simply be placed adjacent each other as shown at adjacent coupling 326. Adjacent coupling 326 has no tabs or other latching or coupling devices. Instead, adjacent coupling 326 is simply two open ended units 310 placed adjacent each other along a pipe 318. While the tension applied by the pipe 318 may act to keep units 310 adjacent one another, the units 310 may also be taped together or the like.

Overlapping coupling 328 illustrates an additional type of coupling between two units 310. In the overlapping coupling 328, the two units 310 overlap each other. In this illustration, one unit 310 has a flange or collar 332 which overlaps the end of the other unit 310 creating a connection between the two units 310. Additionally, tape or the like may be used to secure the two units 310 together.

FIG. 35 also illustrates multiple supports 330 positioned along the open ended units 310. The open ended units 310 are lacking the additional support for pipe 318 that was provided by the pipe openings formed in the distal and proximal ends of the units previously disclosed. Therefore multiple supports 330 may be needed to provide adequate support for pipe 318 or for the unit 310 itself.

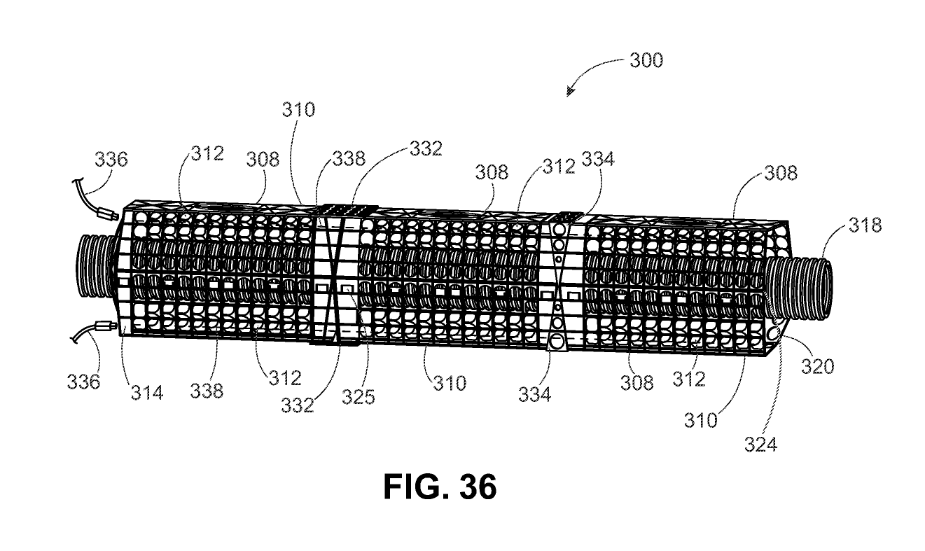

FIG. 36 illustrates open ended units 310 placed adjacent one another. In this illustration, the faces on the units 310 are at an angle in order to allow the sections 308 to be stacked for shipping. The angled faces cause a triangular space between the open ended units 310. In order to prevent debris from falling into these spaces, plate 332 may be placed over the openings. Plate 332 may be a solid, thin rectangular member or plate 332 may have a plurality of openings formed in it as illustrated.

Plate 332 may be any size or shape desired, provided it covers at least one surface of the opening formed between the open ended units 310.

Plate 332 may be coupled over the open space with adhesive, tape, couplers, hook and loop fasteners or the like. Alternatively, plate 332 may be simply placed over the open space without any thing coupling it in place.

An alternative to plate 332 is cover 334. Cover 334 fits into the open space caused by the angled faces on the unit 310. Cover 334 may be a solid triangular wedge shape, or it may have openings as illustrated. Alternatively, cover 334 may have a rectangular plate with a triangular plate positioned perpendicular to it on each of the short ends of the rectangle. When a triangular member 334 shaped in this way is placed into the open space, it covers the edges of the open space leaving an open interior. Cover 334 may be solid or may have openings similar to those in the faces of the units 310.

FIG. 36 also illustrates a camera channel or camera receiver 338. Often in situations where a pipe, drainage area, septic system or the like is located in an inaccessible area such as underground, a camera mounted on the end of a stiff, flexible member may be pushed into the pipe or drainage area in order to allow inspection for any damage, plant growth, fluid buildup or the like. The camera sends a signal back to the camera operator and allows the camera operator to view and inspect the pipe, drainage area or septic system. It may be desirable to allow inspection of both the inside and outside of the pipe used in the aggregate replacement device. Additionally, it may be desirable to inspect the aggregate replacement device itself. In order to allow easy access by camera to the aggregate replacement device and the outside of the pipe, camera receiver openings may be formed in the aggregate replacement device.

Cameras 336 are inserted into aggregate replacement device 300 through camera receiver openings located in the end cap 314 on the aggregate replacement device 300. The cameras 336 are pushed into the aggregate replacement device 300 and follow a camera channel or camera receiver 338 indicated by a dashed line. The camera channel or camera receiver 338 is the path that the camera 336 follows along the aggregate replacement device 300 in order to inspect the pipe 318 and the state of the aggregate replacement device 300 itself.

The camera receiver 338 may be a channel which is formed in the surface of the interior edge of the aggregate replacement device 300. This channel 338 would help to guide the camera, preventing it from moving side to side in the aggregate replacement unit.

In alternative embodiments, the camera channel 338 may be a U shaped opening formed in the edges of the supports inside the aggregate replacement device 300. These openings would help to guide the cameras 336.

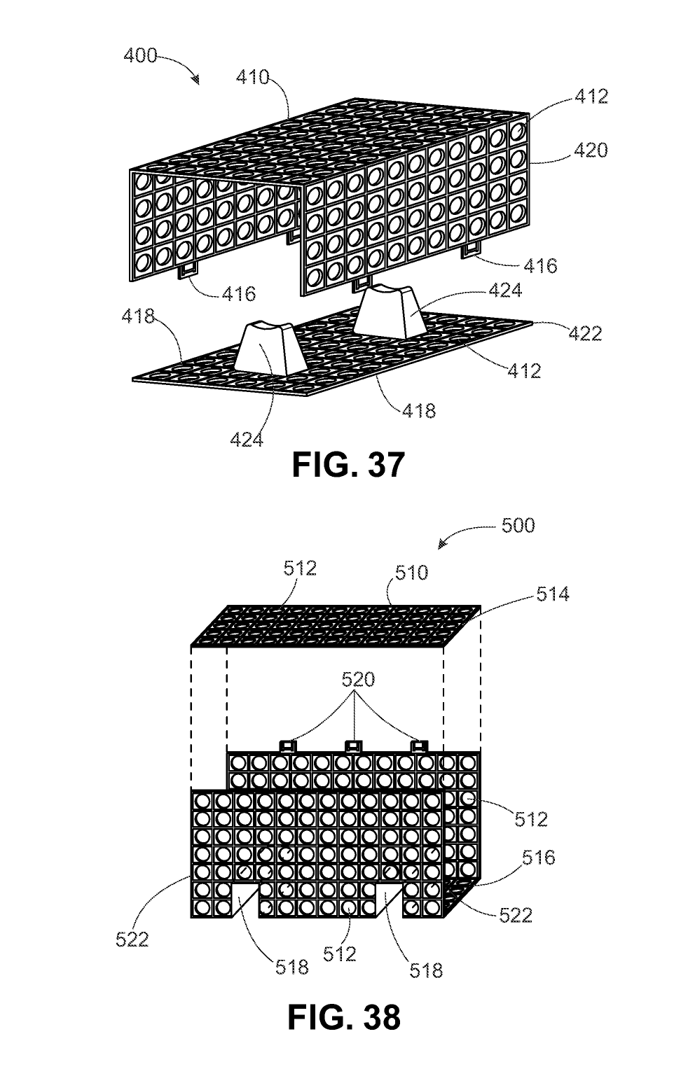

FIGS. 37-42 illustrate alternate configurations or embodiments of open ended aggregate replacement units.

FIG. 37 illustrates an aggregate replacement device 400 formed from a unit 310 with a U shaped upper section 420. U shaped section 420 is formed from three faces coupled together at 90 degree or greater angles. The faces on the U shaped section 420 may be solid or may have a plurality of openings 412 as illustrated.

Additionally, U shaped upper section 420 may include tabs or couplers 416 for coupling U shaped upper section 420 to flat lower section 422.

Flat lower section 422 may be any shape or size desired. Flat lower section 422 is illustrated as a thin rectangular member. Flat lower section 422 may be a solid member or may have openings as illustrated in the figures.

Flat lower section 422 has receivers or couplers 418 formed in its edges to mate with or receive the tabs or couplers 416 on the U shaped upper section 420.

While the couplers 416 and 418 are illustrated as tabs and slots respectively, they may be any type of coupler that secures the U shaped upper section 420 and the fat lower section 422 together. Additionally, couplers 416 and 418 may removably, lockably or permanently couple the two sections together.

Aggregate replacement device 400 additionally has supports 424 coupled to flat lower section 422. Supports 424 may be any size or shape desired to provide support to either a pipe or the unit 410 structure itself. As illustrated, supports 424 may be tapered members with a curved or saddle like upper surface. The curved or saddle like upper surface is designed to support a pipe while helping to maintain the location of the pipe.

Alternate embodiments of supports 424 may include rectangular supports. Supports with flat upper surface.

Additional embodiments may include supports coupled to both the U shaped upper section 420 and to the flat lower section 422. These supports could be aligned directly over each other so that, in pipe-less units, the supports would abut one another and provide additional support to the unit's 410 structure.

FIG. 38 illustrates another embodiment of an open ended aggregate replacement device 500. The aggregate replacement unit 510 illustrated in this figure has a flat upper section 514. Flat upper section 514 is illustrated as a flat rectangular member. However, flat upper section 514 may be any size, shape or curvature desired.

Flat upper section 514 may be a solid member, or it may have a plurality of openings 512. The plurality of openings 512, as discussed in other embodiments, allows fluid to pass into the aggregate replacement device 500.

Flat upper section 514 is coupled to U shaped lower section 516. U shaped lower section 516 is formed from a plurality of faces coupled together at a 90 degree or greater angle. The U shaped lower section 516 illustrated is formed from three faces coupled together in a U shape.

The U shaped lower section 516 may be formed from solid faces or may have a plurality of openings 512 formed in them.

The bottom face of the U shaped lower section 516 includes rectangular supports 518 which extend across the entire bottom surface of the U shaped lower section 516. The supports 518 may support a pipe or may simply provide stability and support to the U shaped lower section 516 of the unit 510.

The supports 518 are also hollow in order to allow multiple U shaped lower sections 516 to be stacked for transport or storage.

The U shaped lower section 516 may also have couplers 520 on at least one edge of the lower section 516. Couplers 520 may be tabs as illustrated with slots to receive the tabs formed in the flat upper section 514 of the unit 510. Additionally, the couplers 520 may be pins and receivers, latches, clips or the like. Couplers 510 may removably, permanently or lockably couple the two sections together.

When U shaped lower section 516 and the flat upper section 514 are coupled together into an aggregate replacement unit 510, the unit 510 has open ends located at edges 522 of the unit 510.

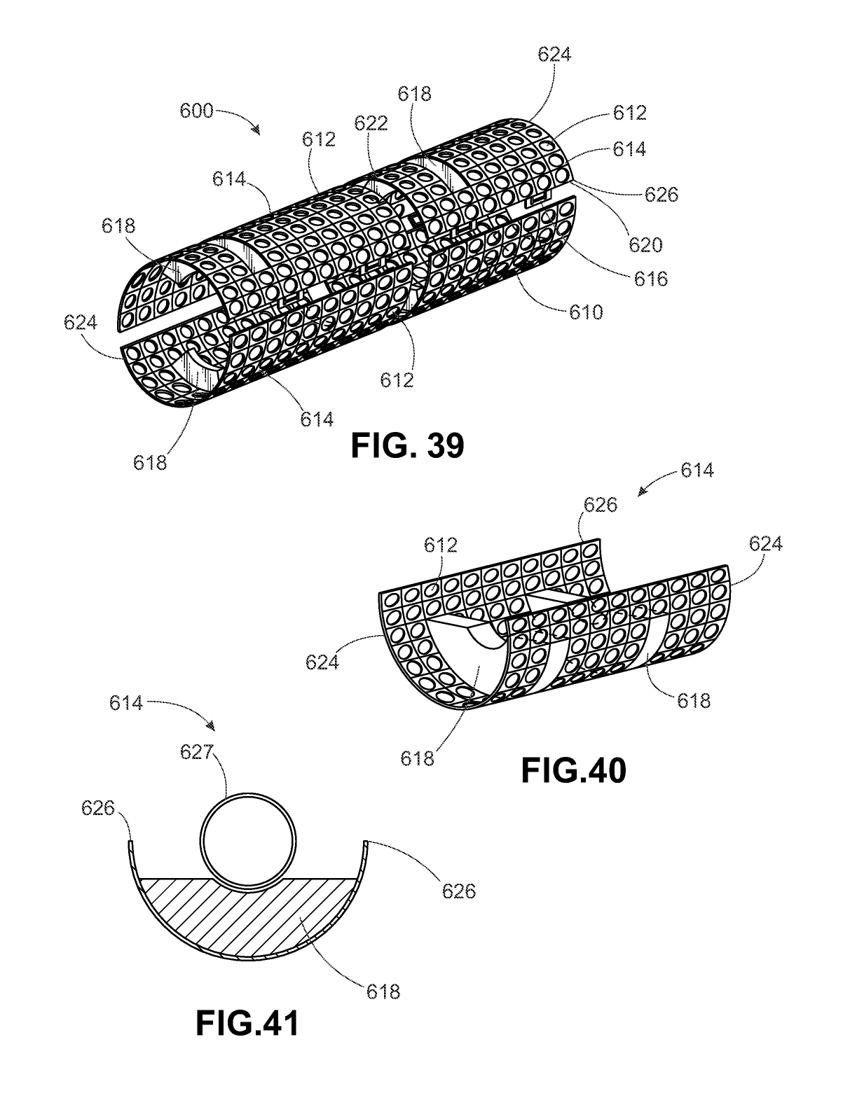

FIGS. 39-41 illustrate a cylindrical embodiment of an open ended aggregate replacement device 600. The cylindrical aggregate replacement device 600 is formed from two curved sections 614 coupled adjacent each other. Multiple cylindrical units 610 may be positioned adjacent each other in order to create a cylindrical aggregate replacement device 600.

The curved sections 614 are rectangular surfaces which have an arched or semi-circular cross-section. The faces may be solid members or may have a plurality of openings 612 formed in them.

The curved section 614 are coupled adjacent one another along edges 626. Edges 626 are the side edges of the sections 614. These edges 626 are coupled together with couplers 616 at seam 620. Couplers 616 may be tabs and slots as illustrated or they may be pins and receivers, clips, latches or the like. Additionally, couplers 616 may removably couple the two sections together or may lock them in place. Couplers 616 may also permanently lock the two sections together.

Sections 614 have supports 618 formed in them. Supports 618 may be any size or shape desired, however, they are illustrated as elongated, tapered supports with a curved upper surface for supporting a pipe. Additionally, the elongated shape of the supports 618 help to provide support to the unit 610 itself.

Supports 618 are illustrated as hollow supports 618 in order to allow the sections 614 to be stackable for transport.

Multiple units 610 may be coupled together at seam 622 in order to form an aggregate replacement device 600.

When multiple units 610 are coupled together both the proximal and distal ends of the aggregate replacement device 600 are open ends 624.

FIG. 40 illustrates a single curved section 614 as discussed in FIG. 39. FIG. 40 and FIG. 41 illustrate an alternate embodiment of supports 618. The supports 618 in these figures extend the entire width of the section 614. This provides added support to the section 614. Additionally, the support 618 has a curved section or saddle which can be used to hold a pipe 627 when desired.

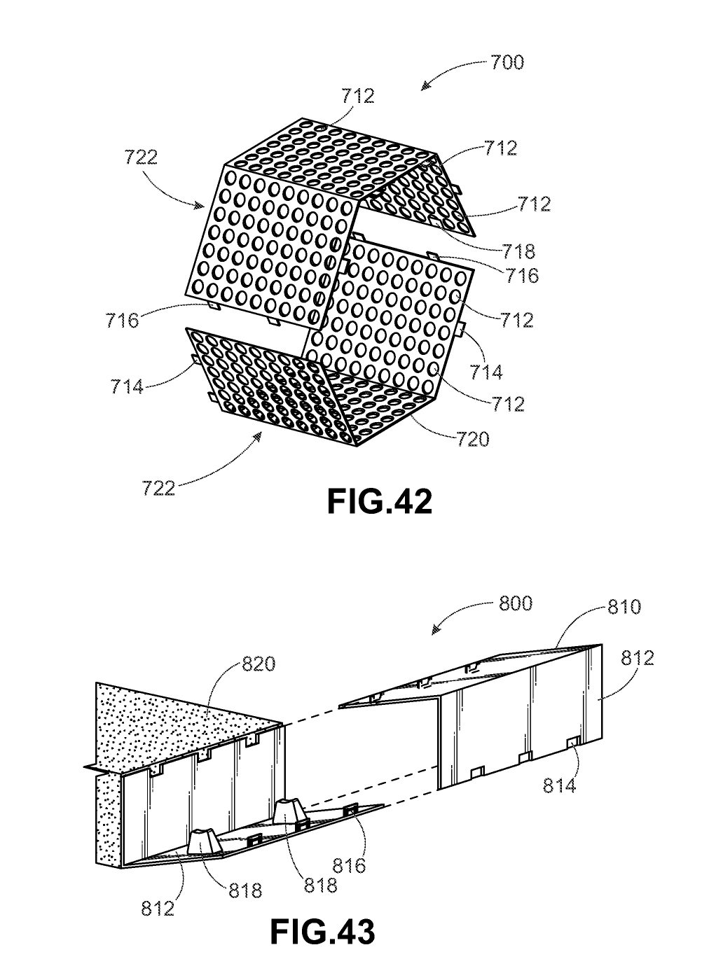

FIG. 42 illustrates another embodiment of an open ended aggregate replacement device 700. The open ended aggregate replacement device 700 in FIG. 42 has a hexagonal cross section when assembled. Each of the two sections 722 are formed from three faces coupled together at an obtuse angle. The obtuse angles allow the sections 722 to be easily stacked for shipping and storage.

The faces used to form the sections 722 may be thin, rectangular solid members or they may have a plurality of openings 712 formed in them as illustrated.

Additionally, couplers may be coupled to the edges of the faces in order to secure the sections 722 together and to secure multiple units of the aggregate replacement 700 to each other. The couplers are illustrated as tabs 716 which may be inserted into slots 718 in order to couple the two sections 722 together. The couplers, however, may be any type of coupling or locking device that will secure the two sections 722 from moving when the aggregate replacement device 700 is installed.

Couplers 714 couple multiple aggregate replacement units together in order to form longer aggregate replacement devices 700. Couplers 714 are positioned along the open proximal or distal ends 720 of the aggregate replacement device 700. Couplers 714 may be any type of coupler desired, such as tabs and slots, pins and receivers, lockers, latches, clips or the like.

In alternate embodiments of aggregate replacement units, particularly those non-rectangular cross-sections, the supports may be positioned at any location on any of the faces. I.e. supports may be positioned at the 6 o'clock and 8 o'clock locations when looking at the cross-section of a section. Supports may also be positioned at the edges of the sections. These supports could be used to help lock the sections together. Additionally, supports located at the edges of the sections would allow the pipe or unit structure to be supported from the 12 o'clock, 3 o'clock, 6 o'clock and 9 o'clock positions or in every quadrant of the unit's cross-section. These additional supports will provide additional strength to the aggregate replacements device's structure allowing the device to be placed in locations where the aggregate replacement device might otherwise be damaged or crushed.

Additionally, if the pipe supports are at locations other than directly perpendicular to the pipe, the path of the camera may be directly along the pipe itself.

In other additional embodiments, the aggregate replacement device may be formed be extrusion. Extrusion allows long sections of aggregate replacement to be formed continuously. However, forming supports at discrete locations along the aggregate replacement sections would be impossible with extrusion. Therefore, in embodiments where extrusion or other similar manufacturing processes are used to form the aggregate replacement sections, a support which runs continuously along the length of the aggregate replacement section may be desired. Additionally, a support that runs the entire length of the aggregate replacement section could also act as, or have formed into it, a camera receiver or guide that directs the path of a camera inserted into the aggregate replacement device.

FIG. 43 illustrates an aggregate replacement device 800, specifically configured to act as a concrete form. Aggregate replacement device 800 is formed from two angled or L shaped sections 812. The two sections 812 may be identical in order to reduce the types of sections that need to be manufactured. When the two sections 812 are coupled together with their open edges abutting each other, they form an aggregate replacement unit 810.

The angled or L shaped sections 812 in this embodiment are formed from two faces coupled together at an approximately 90 degree angle. The faces, as illustrated, are thin rectangular members. In alternate embodiments, the faces may have a plurality of openings formed in them. It may, however, be desirable to use solid faces for the bottom and concrete side faces in this embodiment as illustrated.

In alternate embodiments, the bottom and concrete side faces or the bottom section 812 may be formed from solid faces. The top section 812 may be formed from faces with a plurality of openings. The top section 812 may be wrapped in landscape fabric as discussed previously. The plurality of openings in the top section 812 would allow moisture to enter the aggregate replacement device 800 and be diverted away from the concrete.

The two sections 812 are coupled together through the use of tabs 816 and slots 814. When the two sections 812 are placed abutting each other, the tabs 816 slide into the slots 814 securing the two sections 812 together.

While the couplers in this embodiments are illustrated as tabs 816 and slots 814, any type of coupler may be used, i.e. pins and receivers, locks, clasps, latches, clips, mating slots, male/female couplers and the like. The couplers may permanently, lockably or removably couple the two sections 812 together.

The sections 812 may also include at least one support 818. The supports 818 illustrated taper upwards from the lower surface of the lower section 812. The top of the supports 818 may be concave in order to receive a pipe or the like.

In alternate embodiments, the supports 818 may be taller and may abut supports 818 extending from the upper section 812. This configuration would be primarily used for pipeless units. The supports 818 would provide structural support to the aggregate replacement unit 810.

Multiple aggregate replacement units 810 may be placed end to end in order to form a perimeter for concrete 820. Once the aggregate replacement units 810 are placed in a perimeter, a concrete barrier such as landscaping fabric may be placed over the aggregate replacement device 800 and then concrete 820 may be poured within the perimeter. The aggregate replacement units 810 act as a concrete form as the concrete dries 820.

When being used as a concrete form, the aggregate replacement units 810 may be staked in place to prevent them from slipping and releasing the concrete. The aggregate replacement units 810 may be staked anywhere along the aggregate replacement units 810 that will not interfere with the concrete, i.e. outside of the concrete pour area. Openings may be formed in the aggregate replacement units 810 in order to allow stakes to be driven through the aggregate replacement units 810 for securing them in place. Additionally, stakes may be placed through any of the existing plurality of openings formed in the aggregate replacement units 810.

Multiple aggregate replacement units 810 may be secured together with couplers, tape or the like.

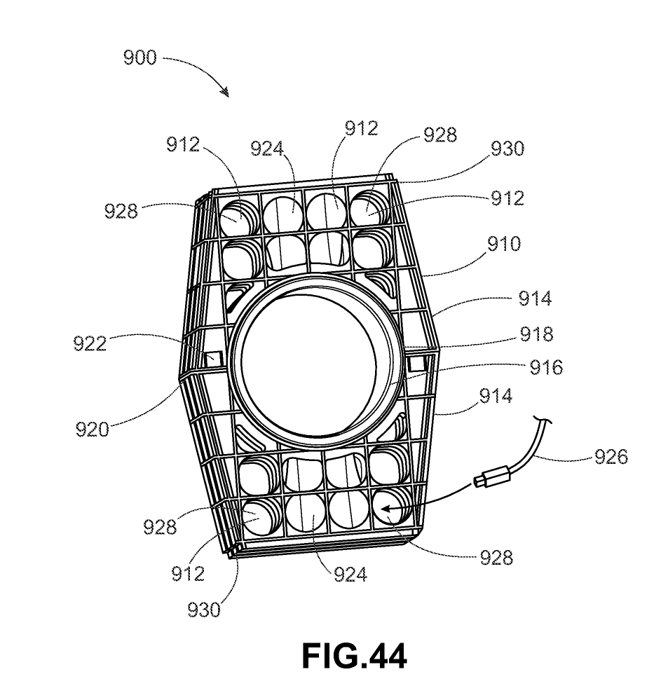

FIG. 44-46 illustrate an aggregate replacement device 900 configured to receive cameras 926. FIG. 44 illustrates an end view of a closed end aggregate replacement unit 910. Aggregate replacement unit 910 is similar to the aggregate replacement unit illustrated in FIG. 24. Aggregate replacement unit 910 has an upper and lower section 914 which are coupled together using couplers 922 at seam 920. The faces of the sections 914 have multiple openings 912 formed in them. A pipe 916 is located in a pipe opening 918 formed by the proximal ends of the sections 914. The pipe 916 is supported by supports 924, which may be tapered supports with a concave top in order to abut pipe 916. The faces are coupled together at obtuse angles 930 in order to allow the sections 914 to be stackable for storage and shipping.

Additionally, the aggregate replacement device 900 has camera receiver openings 928 configured to receive camera 926 and allow camera 926 to be used to inspect the aggregate replacement device 900 and pipe 916.

Camera receiver openings 918 are illustrated as the same size as the other openings 912 in the surface of the aggregate replacement unit 910, however, it is likely that the camera receiver openings 918 will be sized and shaped to particularly receive a camera 926. The camera receiver openings 918 may be circular, square, rectangular, hexagonal, trapezoidal, octagonal, oval or any shape desired. Camera receiver openings 918 may also have a guide that helps the camera 926 to maintain a path along the edge of the aggregate replacement device. This guide may include a channel or other path that the camera 926 may slide along.

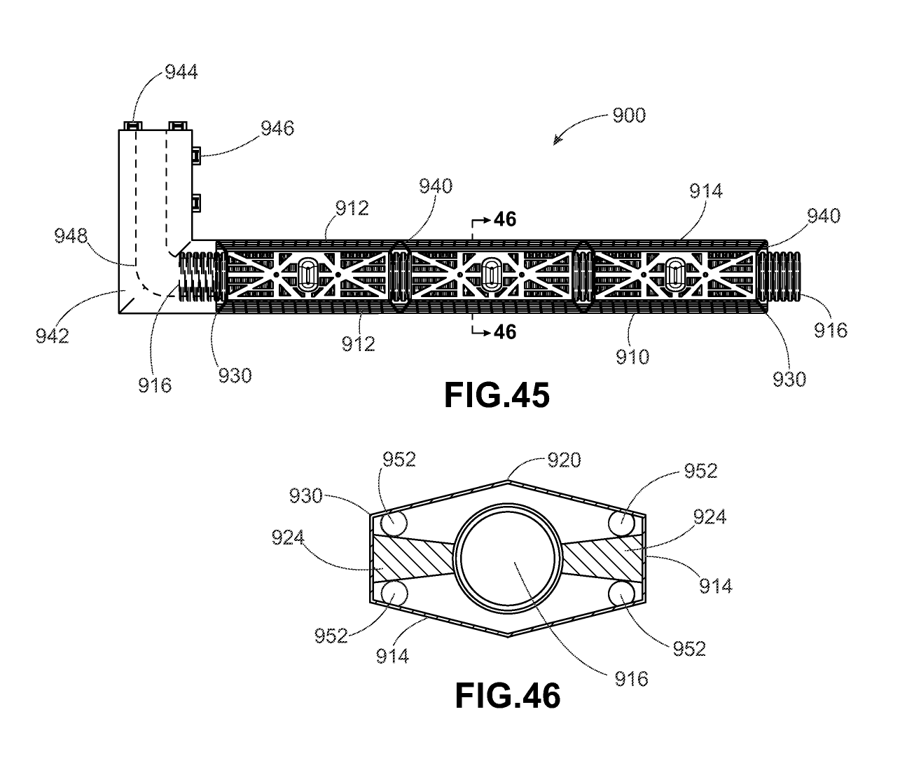

FIG. 45 illustrates an aggregate replacement device 900 laid out in a configuration including an L shaped corner unit 942. Each of the units 910 are illustrated as units 910 with an open end 940. The open ends 940 are angled due to the obtuse angles 930 at which the faces of sections 914 are coupled together. The units 910 are laid end to end with pipe 916 passing through all of the units.

Corner unit 942 is an L or J shaped unit formed from two L or J shaped sections. Corner unit 942 allows the aggregate replacement device 900 to wrap around the corner of a building or the like. The sections are coupled together using couplers 946.

Couplers 946 may be tabs, latches, clasps, pins, locks or the like. Couplers 946 may removably, permanently, or lockably couple the sections together.

Additional units 910 may be coupled to the end of the L shaped unit 942 with couplers 944. Couplers 944 may be tabs, latches, clasps, pins, tape, overlapping, locks or the like. Couplers 944 may removably, permanently, or lockably couple the units together.

L shaped unit 942 also includes camera receiver 948. Camera receiver 948 is a guide which helps a camera to turn the corner in the L shaped unit 942. Camera receiver 948 may be a channel with edges that guide the camera around a corner. Camera receiver 948 may also have openings formed in supports which the camera may pass through. Camera receiver 948 may be anything that guides the camera while still allowing the camera to film the pipe 916 and the aggregate replacement device 900.

FIG. 46 is a cross section of FIG. 45 taken at location 46. This figure illustrates camera receivers 952 which allow a camera to travel along any of the four corners of the aggregate replacement device. These camera receivers 952 are channels or the like formed in the corners of the aggregate replacement device. They allow the cameras to travel along the four locations in order to film the pipe and aggregate replacement device.

FIG. 46 additionally illustrates supports 924 which may be used to support both the pipe 916 and the aggregate replacement structure itself. Supports 924 may be tapered with a concave top in order to abut pipe 916. In alternate embodiments, camera receivers 952 may be formed in the edges of supports 924, i.e. a hole or channel that passes through the bottom edge of supports 924.

Additional embodiments which are formed from all solid faces may be used to protect pipes which are not being used to drain moisture from the surrounding substrate. A solid surface aggregate replacement device would protect the pipes from being damaged by the surrounding substrate. Additionally, the solid surface aggregate replacement device would allow the pipes to be easily, placed, inspected, repaired and replaced.

Accordingly, for the exemplary purposes of this disclosure, the components defining any embodiment of the invention may be formed as one piece if it is possible for the components to still serve their function. The components may also be composed of any of many different types of materials or combinations thereof that can readily be formed into shaped objects provided that the components selected are consistent with the intended mechanical operation of the invention. For example, the components may be formed of rubbers (synthetic and/or natural), glasses, composites such as fiberglass, carbon-fiber and/or other like materials, polymers such as plastic, polycarbonate, PVC plastic, ABS plastic, polystyrene, polypropylene, acrylic, nylon, phenolic, any combination thereof, and/or other like materials, metals, such as zinc, magnesium, titanium, copper, iron, steel, stainless steel, any combination thereof, and/or other like materials, alloys, such as aluminum, and/or other like materials, any other suitable material, and/or any combination thereof.

The embodiments and examples set forth herein were presented in order to best explain the present invention and its practical applications and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. Accordingly, any components of the present invention indicated in the drawings or herein are given as an example of possible components and not as a limitation.

1. An aggregate replacement device comprising:
a first unit having at least two faces, a proximal end and a distal end;
a plurality of openings formed in said at least two faces; and
said at least two faces having a proximal edge, a distal edge and
two side edges, wherein one of said two side edges of a first of said at least two faces is configured to couple to one of said two side edges of a second of said at least two faces.

2. The aggregate replacement device of claim 1, further comprising at least one support coupled to at least one of said at least two faces.

3. The aggregate replacement device of claim 2, wherein said at least one support includes a curved top portion.

4. The aggregate replacement device of claim 1, further comprising at least one support coupled to two of said at least two faces.

5. The aggregate replacement device of claim 1, wherein the first unit is placed adjacent a second unit, wherein the second unit is the same as said first unit.

6. The aggregate replacement device of claim 1, further comprising at least one coupler coupled to said proximal edge of at least one of said at least two faces.

7. The aggregate replacement device of claim 6, wherein said at least one coupler couples the first unit to a second unit, wherein said first unit and said second unit are the same.

8. The aggregate replacement device of claim 1, wherein the first unit overlaps a second unit.

9. The aggregate replacement device of claim 1, wherein two of the at least two faces are bent and coupled together to form the first unit and wherein the first unit is cylindrical.

10. The aggregate replacement device of claim 1, further comprising a camera receiver.

11. An aggregate replacement device comprising:
a first section having a proximal end, a distal end and at least one face and wherein said proximal end and said distal end are open;
at least one coupler coupled to said first section;
a second section having a proximal end, a distal end and at least one face and wherein said proximal end and said distal end are open;
at least one receiver coupled to said second section; and
wherein said first section is configured to couple to said second section with said at least one coupler being received into said at least one receiver to form a unit.

12. The aggregate replacement device of claim 11, wherein said unit is placed adjacent at least one additional unit.

13. The aggregate replacement device of claim 12, wherein said unit and said at least one additional unit are a concrete form.

14. The aggregate replacement device of claim 11, further comprising at least one camera channel for receiving a camera.

15. An aggregate replacement device comprising:
a first unit having at least two faces, a proximal end and a distal end;
a plurality of openings formed in said at least two faces;
said at least two faces having a proximal edge, a distal edge and two side edges, wherein one of said two side edges of a first of said at least two faces is configured to couple to one of said two side edges of a second of said at least two faces; and
a camera receiver formed in said first unit.

16. The aggregate replacement device of claim 15, wherein said camera receiver comprises an opening sized to receive a camera formed in said distal end of said first unit.

17. The aggregate replacement device of claim 15, wherein said camera receiver comprises a channel in at least one of said at least two faces.

18. The aggregate replacement device of claim 17, wherein said channel guides a camera through said aggregate replacement device.

19. The aggregate replacement device of claim 15, wherein said first unit comprises a plurality of camera receivers.

20. The aggregate replacement device of claim 15, wherein said first unit further comprises at least one support coupled to at least one of said at least two faces and wherein said at least one support further comprises a camera receiver.
